(19) United States
(12) Patent Application Publication
(10) Pub. No.: US 2011/0099607 A1
(43) Pub. Date: Apr. 28, 2011

(54) METHOD OF AUTHENTICATING AND BRANDING EMAILS AND OTHER MESSAGES USING INFORMATION AVAILABLE IN A MESSAGE LIST

(75) Inventor: Ram COHEN, Tel Aviv (IL)

(73) Assignee: ACTIVEPATH LTD., Petah-Tiqva (IL)

(21) Appl. No.: 12/911,192

(22) Filed: Oct. 25, 2010

Related U.S. Application Data
(60) Provisional application No. 61/255,107, filed on Oct. 27, 2009.

(51) Int. Cl. G06F 21/20

(52) U.S. Cl. 726/3

(57) ABSTRACT

Disclosed are systems, methods, networks, and computer programs for messaging. In some cases a receiving system receives certain message data which was slated to be presented in a message list to a receiving user, including a sending system contact indicator. In some cases, the receiving system uses the sending system contact indicator in determining where to send a message authentication request in order to reach the system which presumably sent the message. In some cases, the request preferably includes sufficient message identifying information from the received message data for the system which receives the request to find a match among sent messages, provided that the system which received the request had in fact sent the message. In some cases, the system which received the request provides a response to the request which reflects the matching outcome.

### CROSS REFERENCE TO RELATED APPLICATION

This application claims the benefit of U.S. Provisional Application No. 61/255,107, filed on Oct. 27, 2009, which is hereby incorporated by reference herein.

### FIELD OF THE INVENTION

The present invention relates to the field of messaging.

### BACKGROUND OF THE INVENTION

In the related art there are methods for digitally signing an email message (e.g. S/MIME, PGP, DomainKeys) that achieve the desired outcome of sender identity verification. In these methods, in order to verify the signature, access to the raw message data is desired. The raw message data is typically available to email client applications and the operators of the webmail solution but not to the browser by which the user is reading the message. It is noted that more and more users are using a browser for web based emailing rather than using an email client application.

### SUMMARY OF THE INVENTION

According to some embodiments of the invention, there is provided a method, performed by a sending system, of enabling authentication of a message, comprising: adding a sending system contact indicator to a header field of a message, wherein data in the header field is slated to be presented in a message list to a receiving user, the sending system contact indicator including information which directly or indirectly allows for contacting the sending system; sending the message; receiving a request for authentication, the request including message identifying information; matching the message identifying information to data corresponding to the sent message; and providing a response to the request for authentication which reflects an outcome of the matching.

According to some embodiments of the invention, there is also provided a method of attempting to authenticate a message, comprising: using a sending system contact indicator in determining where to send a message authentication request, in order to reach a system which is presumed to have added the indicator to a message header field whose data was slated for presentation in a message list to a receiving user, and to have sent the message; sending the authentication request to where determined, the request including message identifying information that had been included in at least one message header field whose data was slated for presentation in the message list; determining a result of the attempt to authenticate the message, based at least partly on a response received to the request; and reporting that the message is considered authentic, or reporting that the message is considered not authentic.

According to some embodiments of the invention, there is further provided a message sending system, comprising: an authentication information incorporator operable to add a sending system contact indicator to a header field of a message, wherein data in the header field is slated to be presented in a message list to a receiving user, the sending system contact indicator including information which directly or indirectly allows for contacting the sending system; a communicator operable to send the message, and configured to receive a request for authentication including message identifying information; a matcher operable to match the message identifying information to data corresponding to the sent message; and wherein the communicator is further operable to provide a response to the request for authentication which reflects an outcome of the matching.

According to some embodiments of the invention, there is provided a message receiving system, comprising: an authentication handler operable to use a sending system contact indicator in determining where to send a message authentication request, in order to reach a system which is presumed to have added the indicator to a message header field whose data was slated for presentation in a message list to a receiving user and to have sent the message; the authentication handler further operable to send the authentication request to where determined, the request including message identifying information that had been included in at least one message header field whose data was slated for presentation in the message list; the authentication handler further operable to determine a result of the attempt to authenticate the message, based at least partly on a response received to the request; and the authentication handler further operable to report that the message is considered authentic, or further operable to report that the message is considered not authentic.

According to some embodiments of the invention, there is also provided a computer program product comprising a computer useable medium having computer readable program code embodied therein for enabling authentication of a message, the computer program product comprising: computer readable program code for causing the computer to add a sending system contact indicator to a header field of a message, wherein data in the header field is slated to be presented in a message list to a receiving user, the sending system contact indicator including information which directly or indirectly allows for contacting the sending system; computer readable program code for causing the computer to send the message; computer readable program code for causing the computer to receive a request for authentication, the request including message identifying information; computer readable program code for causing the computer to match the message identifying information to data corresponding to the sent message; and computer readable program code for causing the computer to provide a response to the request for authentication which reflects an outcome of the matching.

According to some embodiments of the invention, there is further provided a computer program product comprising a computer useable medium having computer readable program code embodied therein for attempting to authenticate a message, the computer program product comprising: computer readable program code for causing the computer to use a sending system contact indicator in determining where to send a message authentication request, in order to reach a system which is presumed to have added the indicator to a message header field whose data was slated for presentation in a message list to a receiving user, and to have sent the message; computer readable program code for causing the computer to send the authentication request to where determined, the request including message identifying information that had been included in at least one message header field whose data was slated for presentation in the message list; computer readable program code for causing the computer to determine a result of the attempt to authenticate the message, based at least partly on a response received to the request; and computer readable program code for causing the computer to report that the message is considered authentic, or to report that the message is considered not authentic.

### BRIEF DESCRIPTION OF THE DRAWINGS

In order to understand the invention and to see how it may be carried out in practice, embodiments will now be described, by way of non-limiting example only, with reference to the accompanying drawings, in which:

FIG. 1 is a high level block diagram of a network for messaging, according to some embodiments of the invention;

FIG. 2 is a more detailed block diagram of a sending system, according to some embodiments of the invention;

FIG. 3 is a flowchart illustration of a method of sending messages, according to some embodiments of the invention;

FIG. 4 is a more detailed block diagram of a message managing system, according to some embodiments of the invention;

FIG. 5 is a flowchart illustration of a method of managing messages, according to some embodiments of the invention;

FIG. 6 is a more detailed block diagram of a receiving system, according to some embodiments of the invention;

FIG. 7 (comprising FIG. 7A and FIG. 7B) is a flowchart illustration of a method of attempting to authenticate messages, according to some embodiments of the invention;

FIG. 8 is a flowchart illustration of a method of responding to an authentication request, according to some embodiments of the invention;

FIG. 9 is a screenshot of a summary inbox list where no messages are shown as authentic, according to some embodiments of the invention; and

FIG. 10 is a screenshot of a summary inbox list where some messages are shown as authentic, according to some embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

Disclosed are some embodiments of systems, methods, networks, and computer programs for messaging. In some embodiments a receiving system receives certain message data which was slated to be presented in a message list to a receiving user, including a sending system contact indicator. In some embodiments, the receiving system uses the sending system contact indicator in determining where to send a message authentication request in order to reach the system which presumably sent the message. In some embodiments, the request preferably includes sufficient message identifying information from the received message data for the system which receives the request to find a match among sent messages, provided that the system which received the request had in fact sent the message. In some embodiments, the system which received the request provides a response to the request which reflects the matching outcome. These embodiments as well as additional and/or alternative embodiments are described below.

In the following detailed description, numerous specific details are set forth in order to provide a thorough understanding of the invention. However, it will be understood by those skilled in the art that the present invention may be practiced without these specific details. In other instances, well-known methods, procedures and components have not been described in detail so as not to obscure the present invention.

As used herein, the phrase “for example,” “such as”, “for instance” and variants thereof describe non-limiting embodiments of the present invention.

As used herein, and unless explicitly stated otherwise, the term “memory” refers to any module for storing data for the short and/or long term, locally and/or remotely. Examples of memory include inter-alia: any type of disk including floppy disk, hard disk, optical disk, CD-ROMs, magnetic-optical disk, magnetic tape, flash memory, random access memory (RAMs), dynamic random access memory (DRAM), static random access memory (SRAM), read-only memory (ROMs), programmable read only memory PROM, electrically programmable read-only memory (EPROMs), electrically erasable and programmable read only memory (EEPROMs), magnetic card, optical card, any other type of media suitable for storing electronic instructions and capable of being coupled to a system bus, a combination of any of the above, etc.

Reference in the specification to “one embodiment”, “an embodiment”, “some embodiments”, “another embodiment”, “other embodiments”, “one instance”, “some instances”, “one case”, “some cases”, “other cases” or variants thereof means that a particular feature, structure or characteristic described in connection with the embodiment(s) is included in at least one embodiment of the invention. Thus the appearance of the phrase “one embodiment”, “an embodiment”, “some embodiments”, “another embodiment”, “other embodiments” one instance“, “some instances”, “one case”, “some cases”, “other cases” or variants thereof does not necessarily refer to the same embodiment(s).

It should be appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

Unless specifically stated otherwise, as apparent from the following discussions, it is appreciated that throughout the specification discussions utilizing terms such as “authenticating”, “appending”, “sending”, “receiving”, “attempting”, “assisting:, “providing”, “concealing”, “removing”, “checking”, “triggering”, “refreshing”, “responding”, “reporting”, “presenting”, “determining”, “proceeding”, “accessing”, “receiving”, “deleting”, “updating”, “performing”, “incorporating”, “improving”, “adding”, “modifying”, “saving”, “matching”, “identifying”, “recognizing”, “enabling”, “reaching”, “obtaining”, “including”, “causing”, “executing”, “allowing”, “looking-up”, “refreshing”, “caching”, “using”, “handling”, “storing”, “retrieving”, or the like, refer to the action and/or processes of any combination of software, hardware and/or firmware. For example, these terms may refer in some cases to the action and/or processes of a programmable machine, that manipulates and/or transforms data represented as physical, such as electronic quantities, within the programmable machine's registers and/or memories into other data similarly represented as physical quantities within the programmable machine's memories, registers or other such information storage, transmission or display elements.

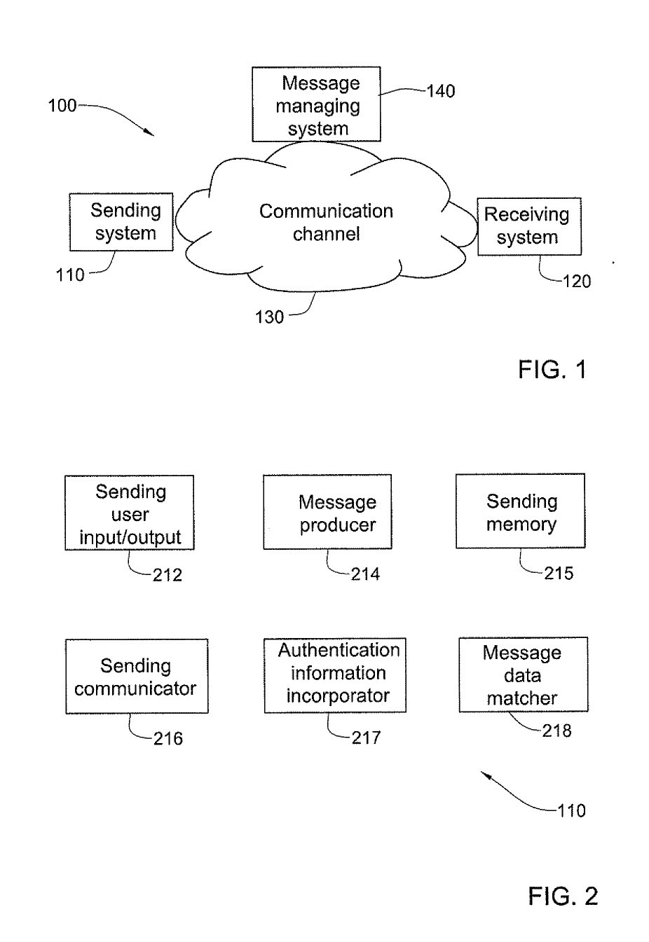

Referring now to the drawings, FIG. 1 illustrates a network 100 for messaging, according to some embodiments of the invention. In the illustrated embodiments, network 100 includes one or more sending systems 110 configured to send messages, one or more receiving systems 120 configured to receive messages, one or more communication channels 130 and optionally one or more message managing systems 140 configured to manage messages. Embodiments of the invention do not limit the type(s) of messages transferred via network 100. Examples of types of messages include: email messages, SMS, social network messages (e.g. Facebook messages, Twitter “tweets”, etc), instant messaging messages, a combination of the above, etc. Each sending system 110, receiving system 120, and message managing system 140 may be made up of any combination of hardware, software and/or firmware capable of performing the operations as defined and explained herein. For example, in some embodiments, any of sending system 110, receiving system 120 and message managing system 140 may comprise a machine specially constructed for the desired purposes, and/or may comprise a programmable machine selectively activated or reconfigured by specially constructed program code. For simplicity of description, sending system 110, receiving system 120, message managing system 140 and communication channel 130 are referred to below in the single form, but such reference should be construed to include embodiments with a single and/or a plural number of system(s)/channel(s), as appropriate for specific implementations and/or particular messages.

Features of sending system 110 may vary depending on the embodiment. For example, in various embodiments sending system 110 may include a user device such as a personal computer, cell phone, smartphone, laptop, tablet computer, etc., may include element(s) which service multiple user devices such as proxy server(s), gateway(s), other types of servers, etc, and/or may include a combination of the above. Depending on the embodiment, modules in sending system 110 may be concentrated in the same location, for example in one unit or in various units in proximity of one another, or modules of sending system 110 may be dispersed over various locations.

Features of receiving system 120 may vary depending on the embodiment. For example, in various embodiments receiving system 120 may include a user device such as a personal computer, cell phone, smartphone, laptop, tablet computer, etc., may include element(s) which service multiple user devices such as proxy server(s), gateway(s), other types of servers, etc, and/or may include a combination of the above. Depending on the embodiment, modules in receiving system 120 may be concentrated in the same location, for example in one unit or in various units in proximity of one another, or modules of receiving system 120 may be dispersed over various locations.

Features of message managing system 140 when included in network 100 may vary depending on the embodiment. In some embodiments, message managing system 140 comprises a gateway, proxy server, other type of server, any other element servicing multiple user devices, etc. Depending on the embodiment, modules in message managing system 140 may be concentrated in the same location, for example in one unit or in various units in proximity of one another, or modules of message managing system 140 may be dispersed over various locations. In embodiments where messages addressed to a receiving user are not managed by message managing system 140, network 100 does not necessarily include message managing system 140.

Features of communication channel 130 may vary depending on the embodiment. For example, in various embodiments, communication channel 130 may comprise any suitable infrastructure for network 100 that provides direct and/or indirect connectivity between any of sending system 110, message managing system 140, and/or receiving system 120, and/or provides direct and/or indirect connectivity between dispersed modules of any of systems 110, 120, and/or 140. Communication channel 130 may use for example one or more wired and/or wireless technology/ies. Examples of channel 130 include cellular network channel, personal area network channel, local area network channel, wide area network channel, internetwork channel, Internet channel, any combination of the above etc.

In some embodiments, a particular location or locations may include a sending system such as system 110 and a receiving system such as system 120 which may or may not be integrated with one another. In these embodiments, the functionality of the particular location(s) with respect to sending and/or receiving may in some cases vary for different messages. In some embodiments, additionally or alternatively a specific location or locations may include only a sending system such as system 110 or only a receiving system such as system 120. In these embodiments, the messaging functionality of the specific location(s) with respect to sending or receiving is unvarying.

In some embodiments, network 100 may include additional functionality for messaging, for example as described in co-pending U.S. application Ser. No. 12/876,384 filed on Sep. 7, 2010, which is hereby incorporated by reference herein.

FIG. 2 is a block diagram of sending system 110, according to some embodiments of the invention. In the illustrated embodiments, sending system 110 includes, a message producer 214 configured to produce a message using data received from a user or using internally generated data, a sending communicator 216 configured to communicate via channel 130, an authentication information incorporator 217 configured to add authentication information to a message, and a messages data matcher 218 configured to match message data for authentication purposes. Optionally, sending system 110 may also include a sending memory 215 configured to store data on sent messages and/or a sending user input/output 212 configured to receive data from a sending user and/or present data to a sending user. Sending system 110 includes at least some hardware and in various embodiments, each of sending user input/output 212, message producer 214, sending memory 215, sending communicator 216, matcher 218, and/or authentication information incorporator 217 may be made up of any combination of hardware, software and/or firmware capable of performing the operations as defined and explained herein. Examples of sending user input/output 212 include: keyboard, mouse, keypad, touch-screen display, microphone, speaker, non-touch-screen display, and/or printer, etc. In some embodiments any of the modules in sending system 110 may be included in any of the following: a web browser; a mail client; an instant messaging client; a peer-to-peer application; a user interface; an SMS application; a messaging application; any other type of Internet client; a plug-in, an add-on, a toolbar or an applet for a browser or a mail client or an instant messaging client; a standalone client; any other suitable element servicing one user device; a gateway; a proxy server; any other type of server; and/or any other suitable element servicing multiple user devices, etc.

In some embodiments, sending system 110 may comprise fewer, more, and/or different modules than those shown in FIG. 2. In some embodiments, the functionality of sending system 110 described herein may be divided differently among the modules of FIG. 2. In some embodiments, the functionality of sending system 110 described herein may be divided into fewer, more and/or different modules than shown in FIG. 2 and/or sending system 110 may include additional, less and/or different functionality than described herein. For example, sending system 110 may include other module(s) for messaging in addition to or instead of one or more of the modules illustrated in FIG. 2. Depending on the embodiment any module in sending system 110 may be concentrated in one unit or separated among two or more units. For example, sending system 110 may include an embedded display or a detached display when input/output 212 includes a display. As another example, additionally or alternatively, in some cases, sending system 110 may be divided into two sub-systems, with a first subsystem optionally including for instance a sending user input/output 212, a message producer 214, and/or a communicator to communicate with the second subsystem, and the second subsystem including for instance sending communicator 216, authentication information incorporator 217, matcher 218, and optionally message producer 214 and/or sending memory 215. In these embodiments, the two subsystems may or may not be located at the same location. For instance, in some cases the first subsystem may correspond to one user device while the second subsystem may correspond to a server in the same domain as the user device which services multiple user devices. In another example, sending system 110 may comprise only the modules listed above for the second subsystem, including for instance sending communicator 216, authentication information incorporator 217, matcher 218, message producer 214, and optionally sending memory 215. As another example, additionally or alternatively, in some cases modules in sending system 110 may be divided between a plurality of elements, with element(s) in the plurality selected from any of the following: a web browser, an email client, an instant messaging client, a peer-to-peer application, a user interface, a messaging application, an SMS application, any other type of Internet client, any other suitable element servicing one user device, a gateway, a proxy server, any other type of server and/or any other suitable element servicing multiple user devices, and with other element(s) in the plurality selected from any of the following: an applet, toolbar, plug-in or add-on to the first element, a standalone element associated with one user device, a gateway, a proxy server, any other type of server and/or any other standalone element servicing multiple user devices. In these embodiments, the various elements may or may not be located at the same location.

In some embodiments, sending system 110 enables authentication of message by receiving system 120. Enabling authentication may include performing one or more of the stages described below with reference to method 300, and/or one or more of the stages described below with reference to method 800. Optionally the enabling authentication may additionally or alternatively include other operations not described with reference to any of these methods.

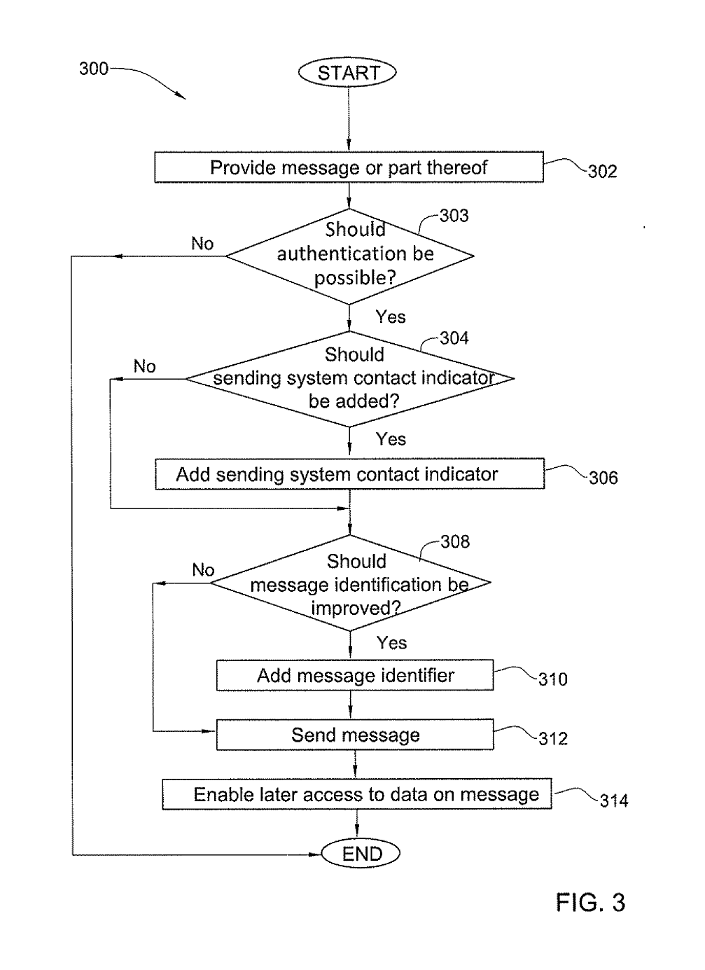

FIG. 3 is a flowchart of a method 300 of sending messages, according to some embodiments of the invention. Method 300 is performed in some embodiments by sending system 110. In some cases, method 300 may include fewer, more and/or different stages than illustrated in FIG. 3, the stages may be executed in a different order than shown in FIG. 3, and/or stages that are illustrated as being executed sequentially may be executed in parallel.

In the illustrated embodiments in stage 302, a message or a part thereof is provided. For example, message producer 214 may produce a message based on user input which was received via sending user input/output 212. In this example, the produced message may be provided to sending communicator 216 or to authentication information incorporator 217 for additional handling and sending, once the user has indicated via sending user input/output 212 that the message should be sent. As another example, the provision of a part of the message may refer to the provision of the user input received via user input/output 212 to message producer 214 so that message producer 214 can produce the message. As another example, message producer 214 may produce a message based on internally generated data and the produced message may be provided to sending communicator 216 or to authentication information incorporator 217 for additional handling and sending. As another example, the provision of a part of the message may refer to the provision of internally generated data to message producer 214 so that message producer 214 can produce the message.

In the illustrated embodiments, in stage 303 it is determined by sending system 110, for instance by authentication information incorporator 217, whether or not it should be possible to authenticate the message. For example, it may be desirable that authentication of some messages is possible but not necessarily desirable that authentication of all messages is possible. In some embodiments, the determination on whether or not it should be possible to authenticate the message may depend on various message parameters such as the message contents, the sending user of the message, address of the receiving user, whether the receiving user is or is not listed in a particular message receiving user field (e.g. “to” field, “cc” field, and/or equivalent), and/or any other message parameter.

If the determination is that authentication of the message should be possible (yes to stage 303) then in the illustrated embodiments method 300 continues with stage 304. If the determination is that authentication should not be possible (no to stage 303) then in the illustrated embodiments method 300 ends and the message production and/or sending proceeds in a known manner. In some embodiments, stage 303 may be omitted, for instance if authentication is possible for all messages sent by sending system 110.

In the illustrated embodiments in stage 304, it is determined by sending system 110, for example by authentication information incorporator 217, whether or not a sending system contact indicator should be added in order to assist receiving system 120 in contacting sending system 100 for message authentication. For example, stage 304 may be performed during the initial production of the message or during the additional handling. In some embodiments, where a sending system contact indicator is never added by sending system 110, for example because receiving system 120 knows where to send an authentication request even if a sending system contact indicator is not added to the message (as will be explained in more detail below), stages 304 and 306 may be omitted.

If the determination is that a sending system contact indicator should be added (yes to stage 304), then in the illustrated embodiments in stage 306, a sending system contact indicator is added by sending system 110, for instance by authentication information incorporator 217. For example, a contact indicator may be generated by authentication information incorporator 217 and added to the message during the initial production of the message by message producer 214. As another example, authentication information incorporator 217 may add a contact indicator to the previously produced message.

In the illustrated embodiments of stage 306 the sending system contact indicator is added to one or more of the header fields of the message whose data is slated to be presented to a receiving user in a message list. Embodiments of the invention do not limit the type of message list and may refer to any list of messages which can be presented to a receiving user. Examples of message lists include inter-glia (summary) inbox message list, priority message list, message folder, deleted items folder, etc. For example, assuming that a message list includes data from header field(s) such as one or more message receiving user field(s) (e.g. “to”, “cc” and/or equivalent), a “From” field and/or equivalent, a “Subject” field and/or equivalent, and/or a “Date/Time” field and/or equivalent, the sending system contact indicator may be located in one or more of the included receiving user field(s), “From” field and/or equivalent, “Subject” field and/or equivalent, and/or “Date/Time” field and/or equivalent. Depending on the embodiment, the added sending system contact indicator may or may not replace some or all of the original contents of the one or more header fields where the indicator is located. For instance, in some cases, the added sending system contact indicator may replace the sending user address (for instance replacing ram@acme.com with sendingsystemindicator@acme.com), with the original sending user address only in the “reply to” header. In another instance, in some cases the added sending system contact indicator may be added as a prefix or suffix to the original contents.

It is noted that data which is slated to be presented in a message list may or may not at the end be presented in the message list. For example, depending on the embodiment, the added sending system contact indicator may or may not be presented to the receiving user (or may only initially be presented to the receiving user). For instance, receiving system 120 may in some cases of this example remove or conceal the indicator as will be explained in more detail below. In another example, additionally or alternatively, in some embodiments data which is slated to be presented in a message list may be presented in addition or instead in another view such as the individual message view. It is also noted that depending on the particular receiving system 120 and/or message managing system 140 corresponding to the receiving user, different data may be considered to be slated to be presented in a message list. For example a receiving system 120 associated with an email client may in some cases present more data in a message list to a receiving user than the data presented in a message list to a receiving user associated with a message managing system 140. Therefore in some embodiments, since sending system 110 is not necessarily aware of the receiving arrangement for a particular receiving user, sending system 110 adds the sending system contact indicator to one or more of the header fields of the message which in most or all receiving arrangements would be slated to be presented to the receiving user in a message list.

Depending on the embodiment and assuming that sending system 110 is performing stage 306 with no fraudulent intent, the added sending system contact indicator may include any suitable information which directly or indirectly allows for contacting sending system 110 in order to authenticate the message. For example, in some embodiments, the sending system contact indicator includes direct contact information which can be used to contact sending system 110, for instance a uniform resource locator URL. Continuing with this instance, in some cases the URL can correspond to a server in sending system 110. In another example, additionally or alternatively, a sending system contact indicator includes (indirect) contact information (such as an identifier of sending system 110) which allows receiving system 120 to look up direct contact information such as a URL, for instance in a look up table accessible by receiving system 120, as will be described in more detail further below.

If instead it is determined that a sending system contact indicator should not be added (no to stage 304), then in the illustrated embodiments stage 306 is omitted. For example in some embodiments, it may be decided not to add a sending system contact indicator for a particular message for instance because receiving system 120 knows where to send an authentication request even if a sending system contact indicator is not added to this particular message (as will be explained in more detail below).

In the illustrated embodiments in stage 308, it is determined by sending system 110, for example by authentication information incorporator 217, whether or not message identification should be improved. For example, stage 308 may be performed during the initial production of the message or during the additional handling. In some embodiments, where no message identification improvement is ever performed by sending system 110, stages 308 and 310 may be omitted. For example, in some of these embodiments, no message identification improvement may be performed by sending system 110 because sufficient data to identify the message may have been provided by the sending user/internal generation and/or by message producer 214 and included in header field(s) whose data is slated to be presented to a receiving user in a message list. In these embodiments data which was included for other use may also serve for authentication purposes.

If the determination is that the message identification should be improved (yes to stage 308), then in the illustrated embodiments in stage 310 a message identifier is added by sending system 110, for instance by authentication information incorporator 217. For example, a message identifier may be generated by authentication information incorporator 217 and added to the message during the initial production of the message by message producer 214. As another example, where the produced message already has an identifier which is located elsewhere than in one of the header fields whose data is slated to be presented to a receiving user in a message list (such as the Message-ID of an email message which may in some cases be located elsewhere), authentication information incorporator 217 may add this identifier or a variation thereof to one or more of the header fields whose data is slated to be presented to a receiving user in a message list. As another example, where the produced message does not already have an identifier, authentication information incorporator 217 may add a message identifier to the message.

In the illustrated embodiments of stage 310, the message identifier is added to one or more of the fields of the message whose data is slated to be presented to a receiving user in a message list. For example, assuming that a message list includes data from header field(s) such as one or more message receiving user field(s), a “From” field and/or equivalent, a “Subject” field and/or equivalent, and/or a “Date/Time” field and/or equivalent, the message identifier may be located in one or more of the included receiving user field(s), “From” field and/or equivalent, “Subject” field and/or equivalent, and/or “Date/Time” field and/or equivalent. Depending on the embodiment, the added message identifier may or may not replace some or all of the original contents of the one or more header fields where the message identifier is located. For instance, in some cases, the message identifier may replace the sending user email address (for instance changing ram@acme.com to id_adsdlh24@acme.com), with the original sending user address only in the “reply to” header. In another instance, in some cases the message identifier may be added as a prefix or suffix to the original contents.

It is again noted that data which is slated to be presented in a message list may or may not at the end be presented. For example, depending on the embodiment, the added message identifier may or may not be presented to the receiving user (or may only initially be presented to the receiving user). For instance, receiving system 120 may in some cases of this example remove or conceal the identifier as will be explained in more detail below. In another example, additionally or alternatively, in some embodiments data which is slated to be presented in a message list may be presented in addition or instead in another view such as the individual message view. It is also noted that depending on the particular receiving system 120 and/or message managing system 140 corresponding to the receiving user, different data may be considered to be slated to be presented in a message list. For example a receiving system 120 associated with an email client may in some cases present more data in a message list to a receiving user than the data presented in a message list to a receiving user associated with a message managing system 140. Therefore in some embodiments, since sending system 110 is not necessarily aware of the receiving arrangement for a particular receiving user, sending system 110 adds the message identifier to one or more of the header fields of the message which in most or all receiving arrangements would be slated to be presented to the receiving user in a message list.

In some embodiments, the message identifier added in stage 310 is unique. In other embodiments the message identifier is not necessarily unique and/or may not be sufficiently long to necessarily counter the possibility of a brute force attack, and therefore in some cases additional identifying information may be required to identify the message besides the identifier.

In some embodiments where both a sending system contact indicator and a message identifier are added, both are included in the same header field. For example, in one of these embodiments, both the sending system contact indicator and the message identifier are appended to the subject header (e.g. if “ch” is the sending system contact indictor and “5Tuv9A” is the message identifier, then “ch5Tuv9a” may be added to the subject header). In other embodiments where both a sending system contact indicator and a message identifier are added, each is not necessarily included in the same header field.

In the illustrated embodiments, if the determination is instead that the message identification should not be improved (no to stage 308) then stage 310 is skipped. For example the determination may be that message identification should not be improved by sending system 110 because sufficient data to identify this particular message may have been provided by the sending user/internal generation and/or by message producer 214 and included in header field(s) whose data is slated to be presented to a receiving user in a message list. In these embodiments data which was included for another use may also serve for authentication purposes of this particular message.

In some embodiments, the sending system contact indicator added in stage 306 and/or the message identifier added in stage 310 also serves as an indication that the message can be authenticated. In some other embodiments (in addition to or instead of the added sending system contact indicator and/or message identifier), sending system 110, for instance authentication information incorporator 217, may add a separate indication that the message can be authenticated in stage 306 or 310 to one or more of the header fields whose data is slated to be presented to a receiving user in a message list. For example, in some cases where a sending system contact indicator is not added by sending system 110 and a message identifier is not added by sending system 110 a separate indication of authentication may be added instead. In still other embodiments, in some cases where a sending system contact indicator and message identifier are not added by sending system 110, a separate authentication indication may nevertheless not be added, for example because receiving system 120 in any event knows that all messages, or all messages of a certain type (for example from a certain sending user), can be authenticated.

In some embodiments, prior to being sent in stage 312, the message may be protected by sending system 110. Protection may include any of the following: encryption, hashing using a one way function, digitally signing, and/or encoding, etc. The protection may have been performed during the initial production of the message, for instance by message producer 214 and/or during additional handling of the produced message after the user has indicated that the message be sent, for instance by authentication information incorporator 217. In other embodiments, the message may not be protected.

In the illustrated embodiments in stage 312 the message is sent by sending system 110, for instance by sending communicator 216.

In some embodiments, the same message may be addressed to a plurality of intended receiving users. In some embodiments with a plurality of intended receiving users, stage 310 is repeated for each intended receiving user so that if a message identifier is to be added, the added message identifier is different for each intended receiving user. In these embodiments, sending stage 312 includes repeating the sending for each message with a different message identifier. In other embodiments, with a plurality of intended receiving users, stage 310 is not necessarily repeated for each receiving user. For example, in some cases a plurality of receiving systems 120 may independently use the same message identifier in separate requests for message authentication.

In the illustrated embodiments, in stage 314 access to data on the sent message is enabled by sending system 110, for instance by matcher 218. For example, sending system 110 may enable access to data by saving data in sending memory 215 and/or by enabling the ability to regenerate data. In some embodiments the stored data and/or data which can be regenerated may include all of the data in the message or only some of the data in the message. For example, in some of these embodiments, the stored data and/or data that can be regenerated includes data from one or more header fields whose data is slated to be presented in a message list to a receiving user. Continuing with the example, and assuming the header fields whose data is slated to be presented include the “from” field and/or equivalent, included receiving user field(s), “subject” field and/or equivalent, date/time field and/or equivalent, and that a message identifier, if added, would have been added to one or more of these header fields, then in some cases the stored data and/or data that can be regenerated may include data from any of these header fields. For instance, in one of these cases of this example the stored data and/or data that can be regenerated may include the identity of the sending user, the identity the receiving user(s), and optionally the subject, date/time of the message and/or message identifier. However, in other instances other data combinations may be stored and/or regenerated.

In some embodiments, the data whose access is enabled in stage 314 at least allows identification of the message in order to respond positively to an authentication request, for example as described below with reference to matching in method 800. For instance, in some cases the data whose access is enabled corresponds to data which would be included in a request for authentication received from receiving system 120, but in other cases the data whose access is enabled may be more, less and/or different than the data which would be included in a request for authentication. Depending on the embodiment, the data whose access is enabled may or may not vary depending on the matching algorithm applied when attempting to match a message and/or based on the minimum probability of match accuracy which is desired for authentication.

In the illustrated embodiments method 300 ends after stage 314.

As mentioned above, the order of stages in method 300 may be varied in some embodiments. For example in some cases the order of stage 312 and 314 may be reversed with stage 314 being performed before stage 312.

In some embodiments a sending system 110 which is fraudulently imitating another sending system 110, may perform stage 306 and add a sending system contact indicator which instead actually corresponds to the other sending system 110. Depending on the embodiment, the fraudulent sending system 110 may perform none, one, some, or all of the other stages in method 300 when fraudulently sending the message. For example, in some of these embodiments, stage 314 may be omitted since the fraudulent sending system 110 would not receive a request for authentication if the added system contact indicator corresponds to another sending system.

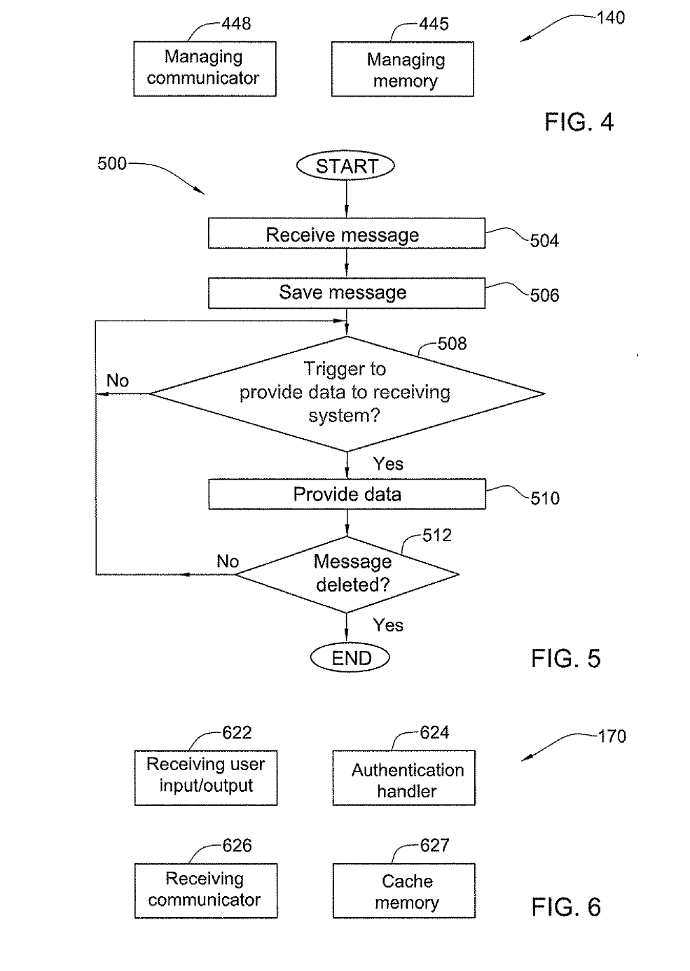

FIG. 4 is a block diagram of optional message managing system 140, according to some embodiments of the invention. In the illustrated embodiments, message managing system 140 includes a managing communicator 448 configured to receive sent messages via channel 130 and configured to communicate with receiving system 120, and a managing memory 445 configured to store received message data. In various embodiments, each of managing communicator 448 and managing memory 445 may be made up of any combination of hardware, software and/or firmware capable of performing the operations as defined and explained herein. For example, in some embodiments message managing system 140 may be associated with a webmail operator.

In some embodiments, message managing system 140 may comprise fewer, more, and/or different modules than those shown in FIG. 4. In some embodiments, the functionality of message managing system 140 described herein may be divided differently among the modules of FIG. 4. In some embodiments, the functionality of message managing system 140 described herein may be divided into fewer, more and/or different modules than shown in FIG. 4 and/or message managing system 140 may include additional, less and/or different functionality than described herein. For example, message managing system 140 may include other module(s) for managing received messages in addition to or instead of one or more of the modules illustrated in FIG. 4. As another example, message managing system 140 may additionally or alternatively include other module(s) relating to managing sent and/or not yet sent message in addition to or instead of one or more of the modules illustrated in FIG. 4, or the illustrated modules may additionally or alternatively include functionality for managing sent and/or not yet sent messages.

FIG. 5 is a flowchart of a method 500 of managing messages, according to some embodiments of the invention. Method 500 is performed by message managing system 140 if message managing system 140 manages messages for a receiving user. In some eases, method 500 may include fewer, more and/or different stages than illustrated in FIG. 5, the stages may be executed in a different order than shown in FIG. 5, and/or stages that are illustrated as being executed sequentially may be executed in parallel.

In the illustrated embodiments, in stage 504 message managing system 140, for example managing communicator 448, receives a message via channel 130 for a receiving user whose messages are managed by message managing system 140. For example, data in message receiving user field(s) may direct the message to message managing system 140.

In the illustrated embodiments, in stage 506, message managing system 140 saves the message for example in managing memory 445.

In the illustrated embodiments in stage 508, it is determined if there is a trigger to provide data in the message to a receiving system 120 currently associated with the receiving user. In some embodiments the provided data at least includes data which was slated to be presented in a message list to the receiving user, although in some cases provided data, if presented, may be presented in a different view to the receiving user such as the individual message view.

The type of trigger may depend on the embodiment. In some embodiments, the trigger may be a query by receiving system 120 and the data is provided when asked for by receiving system 120. In some of these embodiments the query may be caused by an action of the receiving user. For example, for some or all saved messages, data in one or more header fields which is slated to be presented in a message list may be provided when the receiving user logs in via receiving system 120 in order to receive messages, or requests “refresh”, for example by clicking on a refresh, message list, check mail, or other appropriate icon/command via receiving system 120. In another example, additionally or alternatively, data in one or more of these header fields and possibly additional data for a particular message may be provided when the receiving user selects/opens a particular message. In some of these embodiments, additionally or alternatively the query may not be caused by the receiving user. For example, receiving system 120 may periodically ask for data. In some embodiments, additionally or alternatively, the trigger may be the receipt of a new message, and upon receipt of a new message, data in one or more header fields which is slated to be presented in a message list may be provided (pushed) to receiving system 120. For example, in some cases if a new message is received by message managing system 140 while receiving system 120 is presenting the message list to the receiving user, then data in one or more header fields of the message which is slated to be presented in a message list may be pushed to receiving system 120.

If no trigger is present (no to stage 508) then in the illustrated embodiments method 500 waits until a trigger is present. If and when instead a trigger is present (yes to stage 508) then in the illustrated embodiments stage 510 is performed.

In the illustrated embodiments in stage 510 message managing system 140, for instance managing communicator 448, provides to a receiving system 120 currently associated with the receiving user, data in one or more header fields of the received message which is slated to be presented in a message list to the receiving user. For example, in some cases a message list may include data from message receiving user field(s), from a “From” field and/or equivalent, from a “Subject” field and/or equivalent, and/or from a “Date/Time” field and/or equivalent. In some embodiments, additional data may be provided besides data which was slated to be presented in a message list whereas in other embodiments only data which was slated to be presented in a message list is provided.

Depending on the embodiment, the provided data may or may not at the end be presented in a message list. For example as will be explained in more detail in the description of method 700, in embodiments where the message identifier and/or sending system contact indicator are included in the provided data, the message identifier and/or sending system contact indicator may not be presented to the receiving user, may be presented to the receiving user for a limited period of time, or may be presented to the receiving user indefinitely. Additionally or alternatively, in some embodiments, some or all of the provided data may be presented in the individual message view to the receiving user rather than in a message list.

It is noted that a “yes” to stage 508 does not necessarily follow immediately after stage 506 and in some cases stage 510 may need to wait. For example in some cases stage 510 waits until there is a trigger, where the trigger may be for instance the receipt of a query for data by message managing system 140 from receiving system 120.

It is also noted that message data which is not provided in stage 510 to receiving system 120 may in some cases be provided at a different stage by message managing system 140 to receiving system 120. For example, receiving system may request some or all of the additional message data in embodiments where additional authentication procedures are performed, as described further below with reference to method 700.

In the illustrated embodiments, it is determined in stage 512 if the message has or has not been deleted. In these embodiments, if the message has been deleted (yes to stage 512), for instance by receiving user deleting the message via receiving system 120, then method 500 ends because there will no longer be a need to repeat stage 510, However if the message has not been deleted (no to stage 512), then in the illustrated embodiments method 500 iterates back to stage 508 waiting for the next trigger. It is noted that stages 508 and 510 may be performed any number of time(s) depending on the embodiments.

FIG. 6 is a block diagram of receiving system 120, according to some embodiments of the invention. In the illustrated embodiments, receiving system 120 includes a receiving user input/output 622 configured to receive data from a receiving user and/or present data to a receiving user, an authentication handler 624 configured to handle authentication of a message, and a receiving communicator 626 configured to receive data relating to messages from message managing system 140 or from sending system 110. Optionally, receiving system 120 may also include a cache memory 627 configured to store data, for example in order to improve authentication speed. Receiving system 120 includes at least some hardware and in various embodiments, each of receiving user input/output 622, authentication handler 624, receiving communicator 626 and/or cache memory 627 may be made up of any combination of hardware, software and/or firmware capable of performing the operations as defined and explained herein. Examples of receiving user input/output 622 include keyboard, mouse, keypad, touch-screen display, microphone, speaker, non-touch-screen display, and/or printer, etc. In some embodiments any of the modules in receiving system 620 may be included in any of the following: a web browser; a mail client; an instant messaging client; a peer-to-peer application, a user interface; an SMS application; a messaging application, any other type of Internet client; a plug-in, an add-on, a toolbar or an applet for a browser or a mail client or an instant messaging client; a standalone client; any other suitable element servicing one user device; a gateway; a proxy server; any other type of server; and/or any other suitable element servicing multiple user devices, etc.

In some embodiments, receiving system 120 may comprise fewer, more, and/or different modules than those shown in FIG. 6. In some embodiments, the functionality of receiving system 120 described herein may be divided differently among the modules of FIG. 6. In some embodiments, the functionality of receiving system 120 described herein may be divided into fewer, more and/or different modules than shown in FIG. 6 and/or receiving system 120 may include additional, less and/or different functionality than described herein. For example, receiving system 120 may include other module(s) for attempting to authenticate messages in addition to or instead of one or more of the modules illustrated in FIG. 6. Depending on the embodiment modules in receiving system 120 may be concentrated in one unit or separated among two or more units. For example, receiving system 120 may include an embedded display or a detached display when receiving user input/output 622 includes a display. As another example, additionally or alternatively, in some cases, receiving system 120 may be divided into two sub-systems, with a first subsystem including receiving user input/output 622 and optionally a communicator to communicate with the second subsystem, and the second subsystem including receiving communicator 626, authentication handler 624, and optionally cache memory 627. In these embodiments, the two subsystems may or may not be located at the same location. As another example, additionally or alternatively, in some cases the modules in receiving system 120 may be divided between a plurality of elements, with element(s) in the plurality selected from any of the following: a web browser, an email client, an instant messaging client, a peer-to-peer application, a user interface, a messaging application, an SMS application, any other type of Internet client, any other suitable element servicing one user device, a gateway, a proxy server, any other type of server and/or any other suitable element servicing multiple user devices; and with other element(s) in the plurality selected from any of the following: an applet, toolbar, plug-in or add-on to the first element, a standalone element associated with one user device, a gateway, a proxy server, any other type of server and/or any other standalone element servicing multiple user devices. In these embodiments, the various elements may or may not be located at the same location.

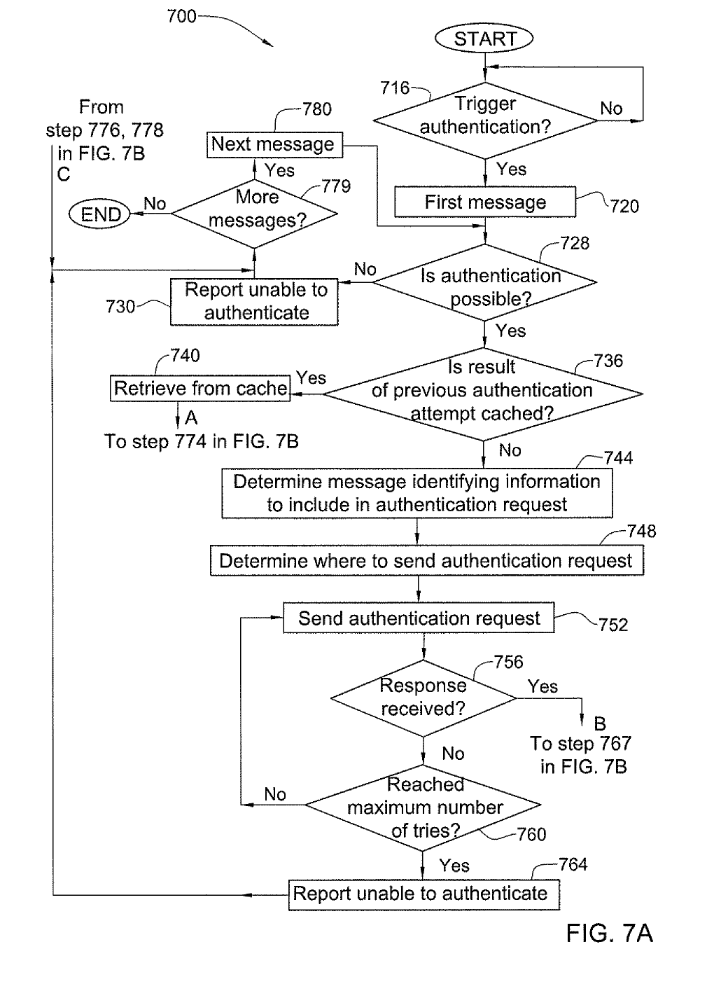

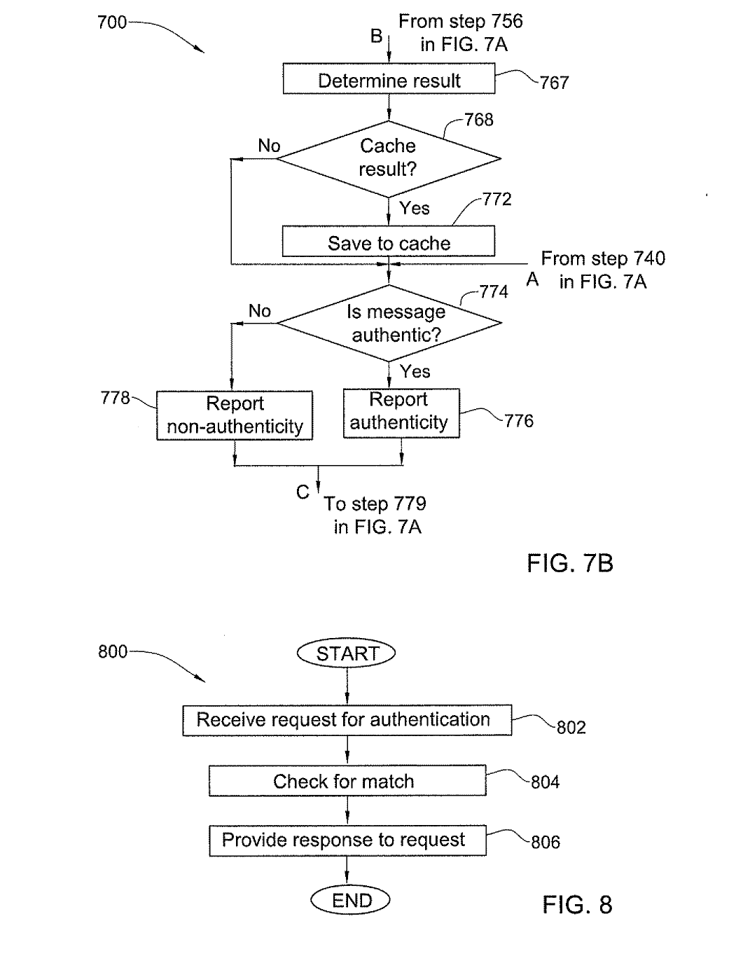

FIG. 7 is a flowchart of a method 700 of attempting to authenticate messages, according to some embodiments of the invention. Method 700 is performed in some embodiments by receiving system 120. In some cases, method 700 may include fewer, more and/or different stages than illustrated in FIG. 7, the stages may be executed in a different order than shown in FIG. 7, and/or stages that are illustrated as being executed sequentially may be executed in parallel.

In the illustrated embodiments, in stage 716, receiving system 120, for instance authentication handler 624, decides whether or not an attempt to determine if received message(s) is/are authentic should be triggered. The invention does not limit the triggering, but for the sake of further illustration to the reader some examples are provided. For example, an attempt to determine if one or more received message are authentic may in some cases be triggered when a message list on receiving user input/output 622 is first presented or each time the list is updated, an attempt may be triggered each time data which was slated to be presented in a message list is provided to receiving system 120, and/or an attempt may be triggered by preparation for presentation of a message list (the first time or each time updated). Continuing with the example, in some cases of this example the trigger may occur after provided data has been received and/or prepared for presentation but not necessarily after provided data has been presented in the message list, meaning that the trigger may occur possibly before any provided data is presented, in parallel with the presentation, or even if provided data will not be presented. Continuing with this example, in some other cases of this example the trigger may necessarily occur after provided data has been presented in the message list. In another example, additionally or alternatively, an attempt to determine if one or more received message are authentic may in some cases be triggered when an individual message view on receiving user input/output 622 is presented, an attempt may be triggered each time data for the individual message view (which at least includes data which was slated to be presented in a message list) is provided to receiving system 120, and/or an attempt may be triggered by preparation for presentation of an individual message view. Continuing with the example, in some cases of this example the trigger may occur after provided data has been received and/or prepared for presentation but not necessarily after provided data has been presented in the individual message view, meaning that the trigger may occur possibly before any provided data is presented, in parallel with the presentation, or even if provided data will not be presented. Continuing with this example, in some other cases of this example the trigger may necessarily occur after provided data has been presented in an individual message view. In the illustrated embodiments, data provided by message managing system 140 or by sending system 110 is received by receiving system 120, for example by receiving communicator 626, and therefore the term “provided data” refers to data provided to receiving system 120. Embodiments do not necessarily limit the timing of when data is provided to receiving system 120, prepared for presentation, and/or presented to the receiving user. For instance, in some embodiments with message managing system 140 the timing of the provision, preparation and/or presentation may depend on a query from receiving system 120 which may or may not have been caused by an action of a receiving user, may depend on receipt of new message(s) by message managing system 140 etc. In some of these embodiments, the receiving user may cause the provision, preparation, and/or presentation by logging in to the mailbox, by clicking on a refresh, message list, check mail, or other appropriate icon/command, selecting/opening an individual message, or by any other appropriate action. In another instance, in some embodiments where messages are received by receiving system 120, the timing of the provision, preparation, and/or presentation may depend on the receipt of new message(s) and/or an action of a receiving user such as logging in to the mailbox, clicking on a refresh, message list, check mail, or other appropriate icon/command, selecting/opening an individual message, or by any other appropriate action. If the decision is that an attempt is not being triggered (no to stage 716) then in the illustrated embodiments, method 700 waits until the decision is that an attempt is being triggered.

If and when instead it is decided that an attempt is being triggered (yes to stage 716), then in the illustrated embodiments in stage 720, receiving system 120, for example authentication handler 624, selects a first message. For instance, in some cases the first message selected may be any of the following: the earliest received message for which data was provided, the latest received message for which data was provided, the message whose provided data includes data from the “From” field or “subject” field which is first in alphabetical order, etc. In another instance, where the trigger was the provision of data for only one message, the preparation for presentation, the presentation in the message list or individual view of only this message, and/or the updating of the message list only for this message (where the message may be for example a message newly received by message managing system 140 or by receiving system 120 or for example a message selected/opened by the receiving user), this message may be selected. However, embodiments of the invention do not limit, in the case of more than one message, the order in which messages are selected, and any appropriate order may be used.

In some embodiments, in order to select the first message and subsequent messages (stage 780), the contents of a message list is analyzed, for example by authentication handler 624. In some of these embodiments relating to webmail, the analysis of the message list may include analyzing the contents of the web page which includes the message list in order to detect the message list. In some of these webmail embodiments, in order to help detect a list, receiving system 120 may first determine which domain (associated with a particular webmail provider, for example, Gmail™, Hotmail, YAHOO!®, etc) corresponds to message managing system 140 and then based on the determined domain, use an algorithm appropriate for that domain to detect the list. For example, the domain may be determined based on the URL of the web page, cookies, content of the web page and/or any other procedure. In some cases of these embodiments, the list of domains associated with webmail providers as well as the algorithm for analyzing the page contents may be updatable over network 100.

In the illustrated embodiments in stage 728, receiving system 120, for instance authentication handler 624, determines if an authentication attempt for the selected message is possible. For example, in some cases, the presence of a message identifier in the provided data, the presence of a sending system contact indicator in the provided data, the message being of a predetermined type for which an authentication attempt is possible (for instance from a particular presumed sending user with which an authentication attempt is possible), and/or the presence of any other indication in the provided data may allow authentication handler 624 to determine that an authentication attempt for the message is possible. Continuing with the example, in some embodiments of these cases, if the domain of the presumed sending user domain address is included in a predetermined listing of domains for which an authentication attempt is possible, then an authentication attempt for the message is possible. Similarly in this example, in some cases, the absence of a message identifier in the provided data, the absence of a sending system contact indicator in the provided data, the message not being of a predetermined type for which an authentication attempt is possible (for instance not from a presumed sending user with which an authentication attempt is possible) and the absence of any other indication may allow authentication handler 624 to determine that an authentication attempt for the message is not possible.

In the illustrated embodiments, authentication handler 624 is able to make a determination of whether or not an authentication attempt for the message is possible based on provided data. For example, in some of these embodiments, assume that data provided to receiving system 120 at least includes data which was slated for presentation in the message list. Assume further in these embodiments that the data which was slated for presentation in the message list corresponds to data in header fields such as message receiving user field(s), a “From” field and/or equivalent, a “Subject” field and/or equivalent, and/or a “Date/Time” field and/or equivalent, then a message identifier, a sending system contact indicator and/or any other indication of authentication, if present, would have been included in one or more of those fields. Depending on the embodiment some or all of the data provided for presentation may have been presented in a message list to a receiving user prior to or in parallel with stage 728 and/or some or all of the data may not as yet have been presented or may never be presented in a message list to a receiving user. In other words, in some embodiments not necessarily all provided data which was slated to be presented in a message list to the receiving user will in fact be presented in a message list, or presented at all. Continuing with these embodiments, some or all of the provided data may in some cases be removed or concealed prior to presentation or may be presented in a different view such as the individual message view, to the receiving user.

In the illustrated embodiments, it may in some cases be advantageous that authentication handler 624 may be able to make a determination of whether or not an attempt to authenticate the message is possible and/or to perform authentication stages 744 or 748 discussed below, based on data provided by message managing system 140 which does not need to be separately requested. For example, it may be faster and/or more efficient for receiving system 120 to make a determination of whether or not an authentication attempt is possible and to perform authentication stages 744 or 748 discussed below, than if the data would need to be separately requested from message managing system 140. In this example, not having to retrieve additional data from message managing system 140 may additionally or alternatively provide the advantage that receiving system 120 does not need to be aware of how a particular message managing system 140 handles data (since receiving system 120 may in some cases be configured to interact with a plurality of message managing systems 140). Additionally or alternatively, it may in some cases be advantageous that authentication handler 624 may be able to make a determination of whether or not an attempt to authenticate the message is possible and/or to perform authentication stages 744 or 748 discussed below, based on data which was slated for presentation in a message list, since this data may be always or almost always provided to receiving system 120 regardless of the receiving arrangement.

If an authentication attempt is determined to not be possible (no to stage 728) then in the illustrated embodiments method 700 proceeds to stage 730 where the inability to determine authenticity is reported to the user, for example by authentication handler 624. For instance, reporting may in some embodiments include providing any appropriate indication that there is no ability to authenticate such as a warning indication of some kind. In some embodiments, the warning indication may be a predefined error image based on the image of the presumed sending system, such as the image of the presumed sending system crossed out or on a red banner, but in other embodiments this is not necessarily the case. In some embodiments, the reporting via the indication and/or any other reporting may include reporting in the message list such as causing a new presentation on receiving user input/output 622 and/or causing modification of an existing presentation on receiving user input/output 622. Continuing with the latter example modification of an existing presentation may in some cases include modification of the presentation of an inbox list. Additionally or alternatively, the reporting via the indication and/or other reporting may include reporting in other non inbox message lists such as message folder, deleted items folder, etc, or in another view such as individual message view, including for example causing a new presentation on receiving user input/output 622 and/or causing modification of an existing presentation on receiving user input/output 622. In some embodiments, however, the inability to determine authenticity is not explicitly reported (and stage 730 is omitted), although in some cases the omission of reporting may be an implicit indication that the message cannot be authenticated. If an authentication attempt is determined to not be possible, then in the illustrated embodiments method 700 proceeds directly to stage 779.

In the illustrated embodiments, if an authentication attempt is instead determined to be possible (yes to stage 728), then method 700 continues with stage 736.

In the illustrated embodiments in stage 736 receiving system 120, for instance authentication handler 624, determines if the result of a previous attempt for authenticating the message is cached and useful, for instance in cache memory 627. For example, in some cases the cache key to identify the corresponding result may include data relating to the request previously sent for authentication (e.g. as sent in a previous iteration of stage 752). For instance, in some cases the data related to the request may include the direct contact information of the presumed sending system 110 (e.g. URL) determined in a previous iteration of stage 748 and message identifying information determined in a previous iteration of stage 744. As another example, additionally or alternatively in some cases the cache key to identify the corresponding result may include message identifying information. Continuing with the example, in some of these cases, the message identifying information includes the identifier that was added for instance in stage 310. Additionally or alternatively in some cases of this example, the message identifying information may include data which is used not only for authentication and which was slated for presentation in the message list. For instance, in some of these cases such data may include data from the “From” field and/or equivalent such as presumed sending user name and/or contact information, the user name and/or contact information of the receiving user corresponding to receiving system 120, data from the “date/time” field and/or equivalent such as date/time sent and/or received, data from the “Subject” field and/or equivalent, and/or any other data which was slated for presentation in the message list. Assuming embodiments where the message identifying information includes both the identifier and data which is used not only for authentication, in some of these embodiments the message identifying information may include at least some of the data from the field in which the identifier is located, and at least some data from the message receiving user field(s). Continuing with these embodiments, and assuming the identifier was located in the “Subject” field or “From” field, then in some instances of these embodiments the message identifying information may include the identifier, optionally other data from the “Subject” or “From” field, and at least some data in message receiving user field(s). In some embodiments, the message identifying information may include at least some of the data from the “From” field and/or equivalent, at least some data from message receiving user field(s), at least some data from the “Subject” field and/or equivalent, at least some data from the date/time field and/or equivalent, and optionally an identifier that was added for instance in stage 310. In another example, additionally or alternatively the cache key may include additional message information used in additional authentication procedure(s) such as a unique webmail message ID or a Message-ID of an email message. In another example, additionally or alternatively the cache key may include an internal indicator of the message which was assigned by receiving system 120 to the corresponding result when the corresponding result was cached.

In the illustrated embodiments, if the corresponding result of a previous authentication attempt is cached and the cached result is useful(“yes” to stage 736), the result is retrieved in stage 740, for example by authentication handler 624 and method 700 then proceeds directly to stage 774.

In some embodiments, any corresponding cached result is considered useful. In other embodiments only if a corresponding cached result is fresh (i.e. less than a predetermined time period has lapsed since the cache entry was inserted to the cache) is the cached result considered useful.

In some embodiments, a corresponding cached result is considered useful regardless of whether or not the trigger for the authentication attempt is the same or different than the trigger which caused the attempt which resulted in the cached result. For instance, in some of these embodiments the triggers may relate to different message lists, or one trigger may relate to a message list and the other to an individual message view. In other embodiments, only if triggers relate to the same message list would the cached result be considered useful.

If instead the corresponding result of a previous authentication attempt is not cached and/or not useful (“no” to stage 736), then in the illustrated embodiments method 700 continues to stage 744.

In embodiments where results of previous attempts of authentication are not cached, for example because there is no cache memory 627, then stage 744 follows directly after a “yes” in stage 728 and stage 736 and 740 are omitted.

In the illustrated embodiments in stage 744, receiving system 120, for instance authentication handler 624, determines message identifying information from the provided data to be included in a request for authentication. As stated above, it is assumed that data provided to receiving system 120 at least includes data which was slated for presentation in the message list. In some embodiments the message identifying information includes data from one or more message header fields which had been slated for presentation in a message list. For example in some of these embodiments, the message identifying information includes the identifier that was added for instance in stage 310. In another example, in some of these embodiments, the message identifying information may additionally or alternatively include data which is used not only for authentication and which was slated for presentation in the message list. For instance, in some cases such data may include data from the “From” field and/or equivalent such as presumed sending user name and/or contact information, the user name and/or contact information of the receiving user, data from the “date/time” field and/or equivalent such as date/time sent and/or received, data from the “subject” field and/or equivalent, and/or any other data which was slated for presentation in the message list. Assuming embodiments where the message identifying information includes both the identifier and data which is used not only for authentication, in some of these embodiments the message identifying information may include at least some of the data from the field in which the identifier is located, and at least some data from the message receiving user field(s). Continuing with these embodiments, and assuming the identifier was located in the “Subject” field or “From” field, then in some instances of these embodiments the message identifying information may include the identifier, optionally other data from the “Subject” or “From” field, and at least some data in message receiving user field(s). In some embodiments, the message identifying information may include at least some of the data from the “From” field and/or equivalent, at least some data from message receiving user field(s), at least some data from “Subject” field and/or equivalent, at least some data from the date/time field and/or equivalent, and optionally the message identifier that was added for instance in stage 310.

In the illustrated embodiments in stage 748, receiving system 120, for example authentication handler 624, determines where to send a request for authentication based on the provided data. As stated above, it is assumed that data provided to receiving system 120 at least includes data which was slated for presentation in the message list. For example, in some embodiments, the data which was slated for presentation in a message list may include a sending system contact indicator which had been added to a message header field, for instance in stage 306. The added sending system contact indicator may include any suitable information which directly or indirectly allows for contacting the presumed sending system 110. Continuing with the example in some embodiments, the sending system contact indicator includes direct contact information which can be used, for instance a URL. Additionally or alternatively in some embodiments of the example, the sending system contact indicator includes (indirect) contact information which allows receiving system 120, for instance authentication handler 624, to look up direct contact information such as a URL. Continuing with these embodiments, in some cases, the indirect contact information may be an identifier of the presumed sending system 110 which can be used by receiving system 120 to look up the corresponding direct contact information (such as a URL) in a look up table which associates identifiers of sending system(s) with corresponding direct contact information. Continuing with these cases, in some of these cases, the sending system identifier may be a globally unique identifier of the sending system of the presumed sending user (e.g. an identifier in the form of “abW_{—}4353” where ‘abW” is globally associated with the “acme.com’ domain would mean that the sending system for the ‘acme.com’ domain is to be queried). For instance, the look up table may be stored in cache memory 627 or in a location in network 100 accessible to receiving system 120. In embodiments with a look up table, the look up table may in some instances be updatable via network 100, and/or may in some instances be managed by one or more sending systems or a third party. For example, receiving system 120 may periodically receive or pull updates of the association between sending system contact indicators and direct contact information. Additionally or alternatively, in embodiments with a look up table, the look up table may in some instances include other parameters relating to sending systems. For instance, in some of these embodiments, additional parameters may include information on how a successful or unsuccessful result of an authentication attempt should be presented to the user. Continuing with this instance, in some of these embodiments, the information would include for a successful attempt styling information to be applied on the sender “From” information and/or an image to be presented, in a message list or other view.

In some other embodiments, additionally or alternatively, receiving system 120 can determine where to send the request for authentication even if a sending system contact indicator was not included in the provided data or the incorrect sending system contact indicator was included in the provided data.

In some of these other embodiments, receiving system 120 determines where to send the request for authentication based on contact information of the presumed sending user. For instance, using (indirectly) the contact information of the presumed sending user (e.g. domain of the email address etc), receiving system 120 can look up in a table the direct contact information (such as URL) of the presumed sending system 110. Continuing with this instance, in some cases the look up table may be stored in cache memory 627 or in a location in network 100 accessible to receiving system 120. In embodiments with a look up table, the look up table may in some instances be updatable via network 100, and/or may in some instances be managed by one or more sending systems or a third party. For example, receiving system 120 may periodically receive or pull updates of the association between contact information of sending users and direct contact information of sending systems. Additionally or alternatively, in embodiments with a look up table, the look up table may in some instances include other parameters relating to sending systems. In some embodiments where the association between contact information of sending users and direct contact information of sending systems as well as the association between indirect and direct contact information of sending systems may be used in stage 748, the associations may be included in one or more look up tables.

In some of these other embodiments the determination of where to send is based on predetermined policy. For example, the predetermined policy may be to send an authentication request simultaneously to all sending systems with which an authentication attempt is possible. As another example, the predetermined policy may be to send an authentication request to sending systems with which an authentication attempt is possible one by one until the correct sending system is reached. As another example, the predetermined policy may be to send an authentication request to one sending system with which an authentication attempt is possible, which then forwards the request to the correct sending system, or forwards the request to all other sending systems with which an authentication attempt is possible, simultaneously or one by one until the correct sending system is reached. In these examples, sending systems which receive irrelevant authentication requests will not find a match or not find a sufficient match and will respond accordingly or not respond at all. In these embodiments, receiving system 120 will determine that a result of the authentication attempt is that the message is authentic as long as one response reflected a positive outcome of matching.

In some cases, a sending system contact indicator which was included in the provided data may be ignored in favor of other embodiments for determining where to send the request for authentication. For example, instead of using the included sending system contact indicator, receiving system 120 may decide to send to the presumed sending system 110 determined by the contact information of the sending user, to all sending systems with which an authentication attempt is possible, or to one such sending system for forwarding.

It is noted that based on the description above, there may be various embodiments where provided data is used to determine where to send the request for authentication. For example, in some of these embodiments, a sending system contact indicator can be used directly or indirectly as described above. In another example, in some of these embodiments, additionally or alternatively, other data such as contact information of the presumed sending user may be used indirectly to determine where to send the request for authentication.

It is also noted however that in some embodiments the data which was slated for presentation to a receiving user in a message list does not necessarily include the domain of the presumed sending user email address. For example, in some of these embodiments the presumed sending user may be identified in the message list by a display name or other name. In these embodiments, without the sending system contact indicator it may be impossible or much more difficult to determine contact information of the presumed sending system 110 based on presumed sending user data. Therefore in these cases the system contact indicator which was added, for example in stage 306, is advantageous in determining where to send the request.

In the illustrated embodiments in stage 752 receiving system 120, for example authentication handler 624, sends the request for authentication, which at least includes the message identifying information determined in stage 744, to the presumed sending system 110 as determined in stage 748.

In some embodiments, prior to being sent in stage 752, at least some of the message identifying information included in the request and/or other data in the request may be protected by receiving system 120. Protection may include any of the following: encryption, hashing using a one way function, digitally signing, and/or encoding, etc. In other embodiments, the request may not be protected.

In some embodiments prior to sending the request for message authentication, receiving system 120 and/or the receiving user may be authenticated and/or identified by the system which receives the request (which presumably is the sending system which sent the message). For example, authentication/identification may be achieved by receiving system 120 providing the correct password, user credentials, etc. In some cases of this example, authentication/identification of receiving system 120 may be automatic, for instance by way of a remembered password or any other authentication item.

In the illustrated embodiments in stage 756, receiving system 120, for instance authentication handler 624, determines if a response to the authentication request has been received. In some embodiments, the user input/output 622 may be modified during the authentication process, for example by displaying an hourglass icon, in order to signal the user that authentication is in progress.

In the illustrated embodiments if no response is received (no to stage 756), then if a predetermined number of maximum tries has not been reached (no to stage 760), then another request is sent in a repetition of stage 752. If instead the predetermined maximum number or tries has been reached (yes to stage 760), then in the illustrated embodiments, in stage 764 the inability to authenticate the message is reported to the receiving user, for example by authentication handler 624 and method 700 then proceeds directly to stage 779. For instance, reporting may in some embodiments include providing any appropriate indication that there is no ability to authenticate such as a warning indication of some kind. In some embodiments, the warning indication may be a predefined error image based on the image of the presumed sending system, such as the image of the presumed sending system crossed out or on a red banner, but in other embodiments this is not necessarily the case. In some embodiments, the reporting via the indication and/or any other reporting may include reporting in the message list such as causing a new presentation on receiving user input/output 622 and/or causing modification of an existing presentation on receiving user input/output 622. Continuing with the latter example causing modification of an existing presentation may in some cases include modification of the presentation of an inbox list. Additionally or alternatively, the reporting via the indication and/or other reporting may include reporting in other non inbox message lists such as message folder, deleted item folders, etc, or in another view such as individual message view, including causing a new presentation on receiving user input/output 622 and/or causing modification of an existing presentation on receiving user input/output 622. In some embodiments, however, the inability to determine authenticity is not explicitly reported (and stage 764 is omitted), although in some cases the omission of reporting may be an implicit indication that the message cannot be authenticated.

In some embodiments, there is no predetermined maximum number of tries, and stage 752 is repeated until a response is received. In these embodiments, stage 760 is omitted.

In some embodiments, if no response is received in stage 756, then there are no additional attempts to authenticate (i.e. stage 760 is omitted) and method 700 proceeds directly to stage 764 or 779.

In the illustrated embodiments, a response may instead be received by receiving system 120, for example by authentication handler 624 (yes to stage 756).

In some embodiments prior to receiving the response, receiving system 120 and/or the receiving user may be authenticated and/or identified by the system which is responding (presumably the sending system which sent the message). For example, authentication/identification may be achieved by receiving system 120 providing the correct password, user credentials, etc. In some cases of this example, authentication/identification of receiving system 120 may be automatic, for instance by way of a remembered password or any other authentication item.

Embodiments of the invention do not limit the form of the received response. In some embodiments, the response reflects an outcome of the matching.

For example, the response may at least include an indication of whether the outcome of the matching was positive or negative. Continuing with the example, in some cases the outcome may be considered positive if all message identifying information included in the request was matched to data corresponding to a message sent by sending system 110, whereas in other cases the outcome may be considered positive even if only part of the included message identifying information was matched. Continuing with this example, in some instances where there is a total or partial match, the response can include the probability that the match is accurate.

In another example, additionally or alternatively, if the outcome of the matching was positive the response may include an image (or a URL thereof) associated with the sending user and/or additional information on how the user input/output 622 should be modified to reflect the successful authentication, such as styling information to be applied on the sender “From” information in a message list, or other view.

In another example, additionally or alternatively, if the outcome of the matching was positive the response may include information pertaining to how the receiving user can contact the sending user such as the sender reply-to address, a URL for composing a response, text of video chat information, etc.

In another example, additionally or alternatively, if the outcome of the matching was positive the response may include information on how the receiving user may obtain further data or support. Continuing with the example, the information may in some cases include additional contact information such as names, email address, URLs, text and/or video chat information, etc.

In another example, additionally or alternatively, if the outcome of the matching was positive the response may include extended information on the sending user, general support information related to the sending user or the organization/company to which the sending user belongs, support information relating to the receiving user of the message such as account manager at the organization/company from which the message was sent, etc.

In embodiments where the outcome of the matching was positive, it is assumed that a certain sending system 110 sent the message, and a request to authenticate the message was sent to the same sending system 110. In these embodiments, the sending system which is presumed based on the message, for instance based on the sending system contact indicator, is the actual sending system. However in some other embodiments there are two sending systems, for the sake of distinction sending system 110A and sending system 110B, where sending system 110A is impersonating sending system 110B. In these embodiments, sending system 110A fraudulently sends a message so that from the message, sending system 110B appears to be the presumed sending system. For example sending system 110A may have added a sending system contact indicator in stage 306 which actually corresponds to sending system 110B. In these embodiments, receiving system 120 in stage 748 determines to send the authentication request for that message to the presumed sending system 110B (which is not the actual sending system). For example, receiving system 120 may use the sending system contact indicator (which was added by fraudulent sending system 110A of the message but which in fact corresponds to sending system 110B) in determining where to send a request in order to reach the presumed sending system. In these embodiments, when sending system 110B receives the authentication request, sending system 110B will be unable or insufficiently able to match message identifying information in the request to data corresponding to messages previously sent by sending system 110B because sending system 110B did not send the message. In these embodiments therefore sending system 110B will provide a response which reflects the negative outcome.

In an example where the outcome of the matching was negative, the response may additionally or alternatively include additional information such as the reason for the negative outcome, contact information for support, warning indication of some kind (such as general warning (e.g. about phishing) and/or predefined error image based on the image of the presumed sending system, e.g. the image of the presumed sending system crossed out or on a red banner), etc.

If a response is received (yes to stage 756) then in the illustrated embodiments in stage 767, receiving system 120, for example authentication handler 624, determines the result (e.g. successful or unsuccessful) of the authentication attempt. In some embodiments the result of the authentication attempt may be based on the received response. For example, the result of the authentication result may repeat the outcome indicated in the response. In another example of these embodiments, the result of the authentication attempt may reflect additional processing of the response. Continuing with the example, in some cases the probability of match accuracy may be determined by receiving system 120, for instance authentication handler 624, depending on one or more factors, for example at least partly dependent on the number of parameters (e.g. number of message identifying information) used to find the match and/or fraction of used parameters which were matched. In embodiments where the probability is computed, there is not necessarily a limitation on the level of sufficient probability and in some cases the required level may be 100% but in other cases the level may be lower. Alternatively, the probability of match accuracy may not be determined by receiving system 120.

In some embodiments, the result of the authentication attempt may be based on the received response as well as on additional authentication procedure(s). In these embodiments, receiving system 120, for example authentication handler 624 performs additional authentication procedure(s) in order to confirm or belie the received response. For example, in some cases additional message information, which was not originally provided to receiving system 120, may be used to confirm or belie the response, such as a unique webmail message ID which may in some cases be separately requested from a webmail application, a Message-ID of an email message, certain elements of the raw message, etc. In some of these cases, this additional information may be requested at this stage from message managing system 140. In some cases where the webmail message ID is used in this stage, the procedure to obtain the webmail message ID may need to be tailored for the specific webmail site/application as the message ID location and the method by which the message is retrieved may vary. As mentioned above, in some embodiments receiving system 120 may be capable of determining which domain (associated with a particular webmail provider) corresponds to message managing system 140. In some of these embodiments, receiving system 120 may at this stage use a procedure appropriate for the determined domain to obtain the webmail message ID. In other embodiments additional authentication procedures are performed which use the provided data. In other embodiments additional authentication procedures are not performed.

In the illustrated embodiments in stage 768 receiving system 120, for example authentication handler 624, determines if the result of the authentication attempt determined in stage 767 should or should not be cached. For example, in various cases results of all authentication attempts are saved, no results are saved, or saving may vary depending on the received response. Continuing with the example, in some case saving may or may not occur depending on any suitable factor, for example ease of re-authentication, amount of time to cache and retrieve versus amount of time to authenticate, content of the response, whether or not the message was authenticated, identity of sending user, amount of space available in cache, configuration of receiving system 120 etc. In some embodiments caching increases responsiveness, decreases the load on network 100, and facilitates communication but in other embodiments caching may not necessarily cause these advantages.

In the illustrated embodiments, if a result of the authentication attempt is to be cached (yes to stage 768) then the result is cached in stage 772, for example in cache memory 627.

Embodiments of the invention do not limit how the result of the authentication attempt is cached. In various embodiments, the result determined in stage 767 is cached, at least some data which was included in the response is stored, at least some data from the additional processing of the response is stored, and/or at least some data resulting from any additional authentication procedures is stored, etc.

In some embodiments, the cached result is associated with a cache key which allows later retrieval of the cached result. For example, in some cases the cache key to identify the corresponding result may include data relating to the request previously sent for authentication in stage 752. For instance, in some cases data relating to the request may include the direct contact information of the presumed sending system 110 (e.g. URL) determined in stage 748 and message identifying information determined in stage 744. As another example, additionally or alternatively in some cases the cache key to identify the corresponding result may include message identifying information. Continuing with the example, in some of these cases, the message identifying information includes the identifier that was added, for instance in stage 310. Additionally or alternatively in some cases of this example, the message identifying information may include data which is used not only for authentication and which was slated for presentation in the message list. For instance, in some of these cases such data may include data from the “From” field and/or equivalent such as presumed sending user name and/or contact information, the user name and/or contact information of the receiving user corresponding to receiving system 120, data from the “date/time” field and/or equivalent such as date/time sent and/or received, data from the “Subject” field and/or equivalent, and/or any other data provided for presentation in the message list. Assuming embodiments where the message identifying information includes both the identifier and data which is used not only for authentication, in some of these embodiments the message identifying information may include at least some of the data from the field in which the identifier is located, and at least some data from the message receiving user field(s). Continuing with these embodiments, and assuming the identifier was located in the “Subject” field or “From” field, then in some instances of these embodiments the message identifying information may include the identifier, optionally other data from the “Subject” or “From” field, and at least some data in message receiving user field(s). In some embodiments, the message identifying information may include at least some of the data from the “From” field and/or equivalent, at least some data from message receiving user field(s), at least some data from the “Subject” field and/or equivalent, at least some data from the date/time field and/or equivalent, and optionally an identifier that was added for instance in stage 310. In another example, additionally or alternatively the cache key may include additional message information used in additional authentication procedure(s) such as a unique webmail message ID or a Message-ID of an email message. In another example, additionally or alternatively the cache key may include an internal indicator of the message which is assigned by receiving system 120.

In some embodiments, the caching is for a limited time period, after which the cached result is deleted from the cache. However, in other embodiments there is no time limitation.

If instead, the authentication result is not to be cached (no to stage 768), then in the illustrated embodiments stage 772 is omitted.

In the illustrated embodiments in stage 774 a decision is made on how to proceed based on whether or not the message is considered authentic. The message may be considered or not considered authentic depending on the determined result of stage 767 or the retrieved result of stage 740.

In the illustrated embodiments, if the message is considered authentic (yes to stage 774), then in stage 776 authenticity is reported, for example by authentication handler 624. In the illustrated embodiments, if the message is not considered to be authentic (no to stage 774) then non-authenticity is reported in stage 778, for example by authentication handler 624. Reporting, for example, may be to the receiving user. In other embodiments, authenticity or alternatively non-authenticity may not be explicitly reported (i.e. stage 776 or alternatively stage 778 may be omitted), but in some cases the omission of reporting may be an implicit indication that the message is authentic or alternatively not authentic.

In some embodiments of stage 776 and/or 778, reporting may include reporting in the message list. For example the reporting in the message list may include causing a new presentation on receiving user input/output 622 for the receiving user and/or causing modification of an existing presentation on receiving user input/output 622 for the receiving user. Continuing with the latter example modification of an existing presentation may in some cases include modification of the presentation of an inbox list. Additionally or alternatively in some embodiments of stage 776 and/or 778, reporting may include reporting in other non inbox message lists such as message folder, deleted item folders, etc or in another view such as individual message view, including causing a new presentation on receiving user input/output 622 and/or causing modification of an existing presentation on receiving user input/output 622.

For instance, in some cases of stage 776, the existing presentation may be modified by showing an image associated with the sending user for each authenticated message and/or by applying styling information on the sender “From” information.

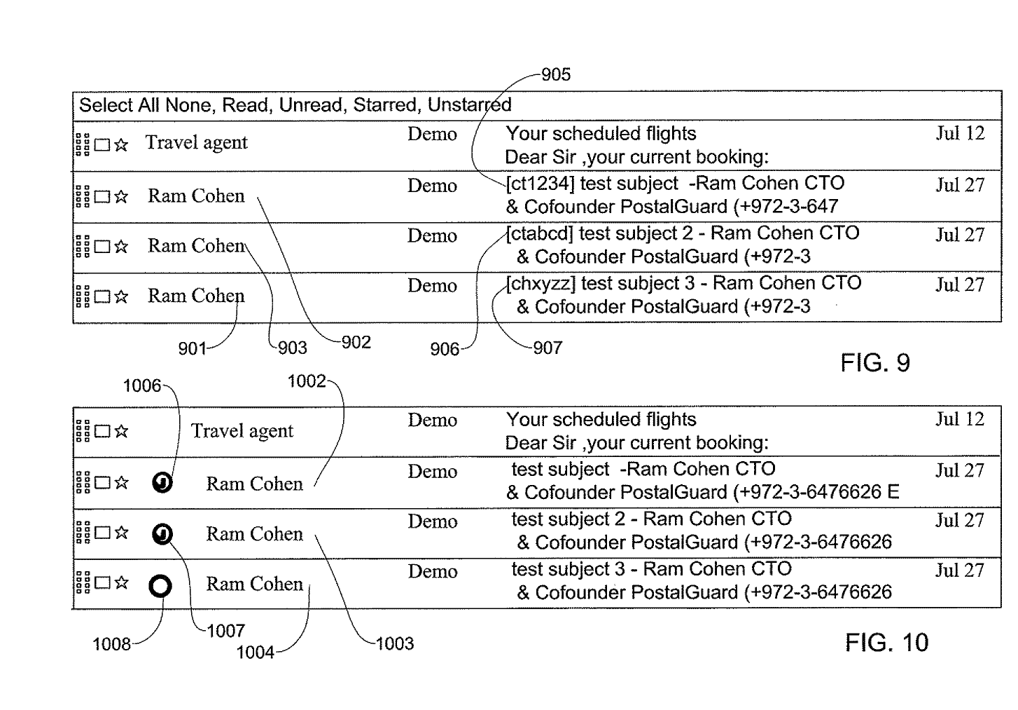

Refer to FIG. 9 and FIG. 10 which are screenshots of a summary inbox list, where messages that are considered authentic include an image associated with the sending user, according to some embodiments of the invention. In FIG. 9 no messages are shown as being authentic. In FIG. 10, the presentations of messages 1002, 1003, and 1004 are shown as being authentic by the addition of image 1006, 1007 and 1008 respectively associated with the sending user. Depending on the embodiment, messages in FIG. 9 or 10 may not be shown as authentic for any reason, for example because of the inability to authenticate, because the message is not considered authentic, because an attempt to authenticate has not yet been attempted, because communication to sending system 110 is not possible, etc.

In some embodiments the reporting for authentic messages in stage 776 may additionally or alternatively include any appropriate indication that the message is considered authentic.

In some embodiments the reporting for authentic messages in stage 776 may additionally or alternatively include information pertaining to how the receiving user can contact the sending user such as the sender reply to address, a URL for composing a response, text and/or video chat information, etc.

In some embodiments, the reporting for authentic messages in stage 776 may additionally or alternatively include information on how the receiving user can obtain further data or support. For example the information can include additional contact information such as names, email addresses, URLs, text and/or video chat information, etc.

In some embodiments, the reporting for authentic messages in stage 776 may additionally or alternatively include extended information on the sending user, general support information related to the sending user or the organization/company to which the sending user belongs, support information relating to the receiving user of the message such as account manager at the organization/company from which the message was sent, etc.

In embodiments where authenticity is reported, the image, indication, and/or information reported in stage 776 may have been received by receiving system 120 as part of the response from sending system 110 for example in stage 756, may have been retrieved by receiving system 120 from storage, for instance from a look up table in cache memory 627 such as previously described, may have been generated by receiving system 120, and/or may have been received independently by receiving system 120, etc, depending on the embodiment. As an example of generation and/or independent receipt, in some embodiments, receiving system 120 may generate and/or receive via network 100 images, indications, and/or information relating to a message once the message has been determined to be authentic.

In some embodiments, the reporting in stage 778 for messages that are considered not authentic may include a warning indication of some sort such as a general warning (e.g. about phishing), additional information such as the reason for the negative outcome, contact information for support, etc. In some embodiments, the warning indication may be a predefined error image based on the image of the presumed sending system, such as the image of the presumed sending system crossed out or on a red banner, but in other embodiments this is not necessarily the case.

It is noted that in some cases where different reasons may lead to authentication failing for a message (e.g. “no” to any of stages 728, 760 and/or 774), reporting may always occur, may never occur, or occurrence/non-occurrence may depend on the reason. In some of these cases where reporting occurs for messages where authentication failed for various different reasons, the reporting may or may not differ depending on the reason.

In embodiments where authentication failure is reported, the indication, additional information and/or contact support reported for messages whose authentication failed (e.g. due to “no” to any of stages 728, 760 and/or 774), may have been received by receiving system 120 as part of the response in stage 756, may have been retrieved by receiving system 120 from storage for instance from a look up table in cache memory 627 such as previously described, may have been generated by receiving system 120, and/or may have been received independently by receiving system 120, etc, depending on the embodiment. As an example of generation and/or independent receipt, in some embodiments, receiving system 120 may generate and/or receive via network 100 indications/information/contact support relating to a message which has not been authenticated.

In some embodiments, there may be a tagging of data relating to the message for which the authentication attempt has been made so that authentication handler 624 and/or the receiving user is aware that an attempt has already been made. In these embodiments, the tagging may or may not be visible in the message list. In other embodiments, this kind of tagging is not performed.

In the illustrated embodiments after stage 776 or 778, method 700 proceeds to stage 779.

In the illustrated embodiments, it is determined in stage 779 whether or not there are any more messages to be selected. If there are no more messages to be selected (no to 779) then in the illustrated embodiments method 700 ends. If there are more messages to be selected (yes to stage 779) then in the illustrated embodiments the next message is selected in stage 780, for example by authentication handler 624, and method 700 iterates to stage 728 for the next message. As mentioned above, embodiments of the invention do not limit, in the case of more than one message, the order that messages are selected and any appropriate order may be used. For instance, in some cases with more than one message the next message selected may be any of the following: the next earliest received message for which data was provided, the next latest received message for which data was provided, the message whose provided data includes data from the “From” field or “subject” field which is next in alphabetical order, etc.

It is noted that depending on the embodiment, the number of messages which are processed before ending method 700 may vary. For example, in some embodiments the message(s) which are processed may be those messages whose data provision preparation for presentation and/or presentation was a trigger in stage 716. In this example, the messages for which data was provided may be all received undeleted messages, may be a subset of the received undeleted messages, may be newly received message(s), may be selected message(s), etc.

In some embodiments, at any stage in method 700 the message identifier, sending system contact indicator and/or other indication of authentication may be removed or concealed by receiving system 120, for instance by authentication handler 624. In some of these embodiments, the removal and/or concealment may occur prior to initial presentation of message data in the message list to the receiving user, or may occur subsequent to the initial presentation. In these embodiments, the message identifier, sending system contact indicator and/or other indication of authentication will therefore eventually not be visible to the receiving user. In some of these embodiments, the removal and/or concealment may occur prior to initial presentation of message data in an individual message to the receiving user, or may occur subsequent to the initial presentation. In these embodiments, the message identifier, sending system contact indicator and/or other indication of authentication will therefore eventually not be visible to the receiving user. In embodiments where concealment is performed, concealment may be achieved in any appropriate way. For example, in some cases, concealment may be achieved by wrapping the data to be concealed (for example message identifier, sending system contact indicator and/or other indication of authentication) in an HTML tag that would conceal the data. For instance, one type of HTML tag which can be used to conceal data is <span style=‘visibility:none’>. In embodiments where removal is performed, removal may be performed in any appropriate way, for example by deleting the unwanted data. In other embodiments a message identifier, a sending system contact indicator and/or another indication of authentication may not be concealed/removed and therefore may continue to be presented to the receiving user at part of the message list and/or individual message view.

Refer again to FIG. 9 and FIG. 10. In the example of FIG. 9 the message presentations 902, 903 and 904 in the summary inbox list includes indicator/identifier 905, 906, and 907 respectively. In this example, the first two letters of each of 905, 906, and 907 make up the sending system contact indicator and the last four characters of each make up the message identifier. However in the same example in FIG. 10, in the corresponding message presentations 1002, 1003 and 1004, the indicator/identifiers are not visible because indicator/identifiers have been concealed and/or removed in this example.

In order to further illustrate embodiments of attempting to authenticate, in accordance with method 700 or any other appropriate method, an example of pseudo code is now provided (with comments on the code in brackets). This example is one possible example of pseudo code for when message managing system 140 corresponds to Gmail webmail provider and the message list is a summary inbox list. Other examples can include less, more and/or different code lines. For instance, a code line presented below may be optional or omitted in another example, whereas in another instance, a different code line that does not appear below may be optional or mandatory.
Is the URL of the page of gmail? If no, stop
Get gmail user name by looking at the browser cookies and/or page content
   Get all table elements in the page, and for each table, check if it contains certain HTML elements that exist only in the inbox table
   If such a table is found, loop on all table rows (each row being for a single message)
   For each row, get the data of the sender, subject and date by looking at the matching columns. (Algorithm knows which columns to look at because the algorithm knows the table structure, so the algorithm knows for example that the 3^{rd} column is that of the sender)
      Check if the subject contains marker ([db4gfd2] for example) and if the code (db) is of a provider known to the application
      Query the server associated with ‘db’, providing it with the above information from the table plus the gmail user name
      Decorate the row according to the result
      Tag the row and/or columns (so as to know that already checked this row/columns)

FIG. 8 is a flowchart of a method 800 of responding to an authentication request, according to some embodiments of the invention. Method 800 is performed in some embodiments by sender system 110. In some cases, method 800 may include fewer, more and/or different stages than illustrated in FIG. 8, the stages may be executed in a different order than shown in FIG. 8, and/or stages that are illustrated as being executed sequentially may be executed in parallel.

In the illustrated embodiments in stage 802, a request for authentication of a message is received by the presumed sending system 110, for example by communicator 216, from receiving system 120. As mentioned above, in these embodiments the request for authentication at least includes message identifying information. For example in some embodiments, the message identifying information includes the identifier that was added for instance in stage 310. In another example, in some embodiments, the message identifying information may additionally or alternatively include data which is used not only for authentication and which was slated for presentation in a message list. For instance, in some cases such data may include data from the “From” field and/or equivalent such as presumed sending user name and/or contact information, the user name and/or contact information of the receiving user, data from the “date/time” field and/or equivalent such as date/time sent and/or received, data in the “Subject” field and/or equivalent, and/or any other data slated for presentation in the message list. Assuming embodiments where the message identifying information includes both the identifier and data which is used not only for authentication, in some of these embodiments the message identifying information may include at least some of the data from the field in which the identifier is located, and at least some data from the message receiving user field(s). Continuing with these embodiments, and assuming the identifier was located in the subject field or “From” field, then in some instances of these embodiments the message identifying information may include the identifier, optionally other data from the “Subject” or “From” field, and at least some data in message receiving user field(s). In some embodiments, the message identifying information may include at least some of the data from the “From” field and/or equivalent, at least some data from message receiving user field(s), at least some data from “Subject” field and/or equivalent, at least some data from the date/time field and/or equivalent, and optionally the message identifier that was added for instance in stage 310.

In some embodiments, prior to stage 802, presumed sending system 110, for instance communicator 216, may authenticate and/or identify receiving system 120 and/or the receiving user. For example, authentication/identification may be achieved by checking that receiving system 120 provides the correct password, user credentials, etc. In some cases of this example, authentication/identification may be automatic, for instance by way of a remembered password or any other authentication item.

In the illustrated embodiments in stage 804, presumed sending system 110, for instance matcher 218, tries to find among sent messages a matching message to the message associated with the received request. Depending on the embodiment, data on sent messages may have been saved for instance in memory 215 and/or presumed sending system 110 may be capable of regenerating data on sent messages, as described earlier with reference to stage 314.

In some embodiments, it is determined if the message identifying information included in the request matches data corresponding to a sent message. In some of these embodiments, the message identifying information included in the request includes an identifier (for example as added in stage 310). In these embodiments, provided the presumed sending system 110 which received the request had in fact sent the message, the identifier is sufficient for sending system 110 to match with an acceptable probability of accuracy, the message associated with the request. In some other embodiments, the message identifying information includes, in addition to or instead of an identifier, other identifying data which enables matching of the associated message with an acceptable probability of accuracy. For example, in some of the latter embodiments, the identifier may not be unique or may not be sufficiently long to counter the possibility of a brute force attack, and therefore in order to enable identification with an acceptable probability of accuracy, other identifying data may in some cases be required. As another example, in some of the latter embodiments, other identifying data may be used instead of the identifier. The other identifying data is not limited by embodiments of the invention but for the sake of further illustration to the reader some examples include message list data used not only for authentication such as data from the “From” field and/or equivalent such as presumed sending user name and/or contact information, the user name and/or contact information of the receiving user, data from the “date/time” field and/or equivalent such as date/time sent and/or received, data in the “Subject” field and/or equivalent, and/or any other data in the message list.

In some embodiments, where the request includes message identifying information comprising a plurality of identifying data (e.g. a combination of identifier and one or more other identifying data, two or more other identifying data, etc), the outcome of the matching may be considered positive if all message identifying information included in the request were matched to data corresponding to a message sent by sending system 110, whereas in other embodiments the outcome may be considered positive even if only part of the included message identifying information was matched. Continuing with this example, in some cases where there is a total or partial match, the probability that the matching is accurate may be calculated by matcher 218. For instance the probability of match accuracy may be determined in some of these cases, depending on one or more factors, for example at least partly dependent on the number of parameters (e.g. number of message identifying information) used to find the match and/or fraction of used parameters which were matched. In embodiments where the probability is computed, there is not necessarily a limitation on the level of sufficient probability and in some cases the required level may be 100% but in other cases the level may be lower. Alternatively, the probability of match accuracy may not be determined by sending system 110.

In some embodiments, where the system which received the request is not the system which sent the message, the system which received the request will not be able to match or will not be able to sufficiently match the message identifying information included in the request to data corresponding to a sent message,

Embodiments of the invention do not limit the matching algorithm used to determine whether or not there is a match. However for the sake of further illustration to the reader, one possible example of matching algorithm is now described. In this example, matcher 218 checks that a message with the identifier specified in the request was sent to the receiving user specified in the request and that the sent message subject starts with the subject specified in the request.

In the illustrated embodiments in stage 806, presumed sending system 110, for instance sending communicator 216, provides a response to the request.

Embodiments of the invention do not limit the form of the response. In some embodiments, the response reflects an outcome of the matching.

For example, the response may at least include an indication of whether the outcome of the matching was positive or negative. Continuing with the example, in some cases the outcome may be considered positive if all message identifying information included in the request was matched to data corresponding to a message sent by sending system 110, whereas in other cases the outcome may be considered positive even if only part of the included message identifying information was matched. Continuing with this example, in some instances where there is a total or partial match, the response can include the probability that the match is accurate. Alternatively, the probability may be determined by receiving system 120 or may not be determined.

In another example, additionally or alternatively, if the outcome of the matching was positive the response may include an image (or a URL thereof) associated with the sending user and/or additional information on how the user input/output should be modified to reflect the successful authentication, such as styling information to be applied on the sender “From” information in a message list or other view.

In another example, additionally or alternatively, if the outcome of the matching was positive the response may include information pertaining to how the receiving user can contact the sending user such as the sender reply-to address, a URL for composing a response, text of video chat information, etc.

In another example, additionally or alternatively, if the outcome of the matching was positive the response may include information on how the receiving user may obtain further data or support. Continuing with the example, the information may in some cases include additional contact information such as names, email address, URLs, text and/or video chat information, etc.

In another example, additionally or alternatively, if the outcome of the matching was positive, the response may include extended information on the sending user, general support information related to the sending user or the organization/company to which the sending user belongs, support information relating to the receiving user of the message such as account manager at the organization/company from which the message was sent, etc.

In an example where the outcome of the matching was negative, the response may additionally or alternatively include additional information such as the reason for the negative outcome, contact information for support, warning indication of some kind (such as general warning (e.g. about phishing) and/or predefined error image based on the image of the presumed sending system, e.g. the image of the presumed sending system crossed out or on a red banner)), etc.

In some embodiments, prior to being sent in stage 806, at least some of the response may optionally be protected by presumed sending system 110. Protection may include any of the following: encryption, hashing using a one way function, digitally signing, and/or encoding, etc. In other embodiments, the response may not be protected.

In some embodiments, prior to sending the response in stage 806, presumed sending system 110, for instance communicator 216, may authenticate and/or identify receiving system 120 and/or the receiving user. For example, authentication/identification may be achieved by checking that receiving system 120 provides the correct password, user credentials, etc. In some cases of this example, authentication/identification may be automatic, for instance by way of a remembered password or any other authentication item.

It will also be understood that in some embodiments a system or part of a system according to the invention may be a suitably programmed machine. Likewise, some embodiments of the invention contemplate a computer program being readable by a machine for executing a method of the invention. Some embodiments of the invention further contemplate a machine-useable medium tangibly embodying program code readable by the machine for executing a method of the invention.

While the invention has been shown and described with respect to particular embodiments, it is not thus limited. Numerous modifications, changes and improvements within the scope of the invention will now occur to the reader.

1. A method, performed by a sending system, of enabling authentication of a message, comprising:
adding a sending system contact indicator to a header field of a message, wherein data in said header field is slated to be presented in a message list to a receiving user, said sending system contact indicator including information which directly or indirectly allows for contacting said sending system;
sending said message;
receiving a request for authentication, said request including message identifying information;
matching said message identifying information to data corresponding to said sent message; and
providing a response to said request for authentication which reflects an outcome of said matching.

2. The method of claim 1, wherein said sending system contact indicator includes a uniform resource locator.

3. The method of claim 1, further comprising:
adding a message identifier to at least one message header field, wherein data in said header field is slated to be presented in a message list to a receiving user.

4. The method of claim 3, wherein said message identifying information includes said message identifier.

5. The method of claim 3, wherein both said sending system contact indicator and said message identifier are added to the same header field.

6. The method of claim 1, wherein said message identifying information includes data used not only for authentication from at least one header field which is presented to a receiving user in a message list.

7. The method of claim 1, wherein said header field is the Subject header field or From header field or equivalent.

8. A message receiving system, comprising:
an authentication handler operable to use a sending system contact indicator in determining where to send a message authentication request, in order to reach a system which is presumed to have added said indicator to a message header field whose data was slated for presentation in a message list to a receiving user and to have sent said message;
said authentication handler further operable to send said authentication request to where determined, said request including message identifying information that had been included in at least one message header field whose data was slated for presentation in said message list;
said authentication handler further operable to determine a result of said attempt to authenticate said message, based at least partly on a response received to said request; and
said authentication handler further operable to report that said message is considered authentic, or further operable to report that said message is considered not authentic.

9. The system of claim 8, wherein said message identifying information includes a message identifier.

10. The system of claim 9, wherein both said sending system contact indicator and said message identifier were added to the same header field.

11. The system of claim 8, wherein said authentication handler is further operable to conceal or remove said sending system contact indicator or at least part of said message identifying information before said sending system contact indicator or said at least part of said message identifying information is presented to said receiving user or after presentation at least one time to said receiving user.

12. The system of claim 8, wherein said authentication handler is operable to use said sending system contact indicator to look up direct contact information corresponding to said sending system contact indicator in determining where to send said request.

13. The system of claim 8, wherein said sending system contact indicator includes a uniform resource locator.

14. The system of claim 8, wherein said authentication handler is further operable to determine that an authentication attempt should be triggered when said message list is presented or said presentation is updated.

15. The system of claim 8, wherein said authentication handler is further operable to analyze the contents of a webpage for said message list in order to detect said message list.

16. The system of claim 8, further comprising a cache memory, wherein said authentication handler is further operable to determine whether or not a previous result of an authentication attempt for said message is cached and useful;
if not, then said authentication handle is operable to proceed to use said sending system contact indicator in determining where to send a message authentication request and to send said request; and
if instead a previous result is cached and useful then said authentication handler is further operable to retrieve said previous result and report that said message is considered authentic, or report that said message is considered not authentic.

17. The system of claim 8, further comprising a cache memory operable to store said determined result.

18. The system of claim 8, further comprising a user input/output operable to present said message list to said receiving user.

19. The system of claim 8, wherein said message being considered authentic or said message being considered not authentic is reported in said message list.

20. The system of claim 8, wherein said message identifying information includes data used not only for authentication.

21. The system of claim 8, further comprising a communicator operable to receive data relating to a message, including said sending system contact indicator.

22. A message sending system, comprising:
an authentication information incorporator operable to add a sending system contact indicator to a header field of a message, wherein data in said header field is slated to be presented in a message list to a receiving user, said sending system contact indicator including information which directly or indirectly allows for contacting said sending system;
a communicator operable to send said message, and configured to receive a request for authentication including message identifying information;
a matcher operable to match said message identifying information to data corresponding to said sent message; and
wherein said communicator is further operable to provide a response to said request for authentication which reflects an outcome of said matching.

23. A method of attempting to authenticate a message, comprising:
using a sending system contact indicator in determining where to send a message authentication request, in order to reach a system which is presumed to have added said indicator to a message header field whose data was slated for presentation in a message list to a receiving user, and to have sent said message;
sending said authentication request to where determined, said request including message identifying information that had been included in at least one message header field whose data was slated for presentation in said message list;
determining a result of said attempt to authenticate said message, based at least partly on a response received to said request; and
reporting that said message is considered authentic, or reporting that said message is considered not authentic.

24. A computer program product comprising a computer useable medium having computer readable program code embodied therein for enabling authentication of a message, the computer program product comprising:
computer readable program code for causing the computer to add a sending system contact indicator to a header field of a message, wherein data in said header field is slated to be presented in a message list to a receiving user, said sending system contact indicator including information which directly or indirectly allows for contacting said sending system;
computer readable program code for causing the computer to send said message;
computer readable program code for causing the computer to receive a request for authentication, said request including message identifying information;
computer readable program code for causing the computer to match said message identifying information to data corresponding to said sent message; and
computer readable program code for causing the computer to provide a response to said request for authentication which reflects an outcome of said matching.

25. A computer program product comprising a computer useable medium having computer readable program code embodied therein for attempting to authenticate a message, the computer program product comprising:
computer readable program code for causing the computer to use a sending system contact indicator in determining where to send a message authentication request, in order to reach a system which is presumed to have added said indicator to a message header field whose data was slated for presentation in a message list to a receiving user, and to have sent said message;
computer readable program code for causing the computer to send said authentication request to where determined, said request including message identifying information that had been included in at least one message header field whose data was slated for presentation in said message list;
computer readable program code for causing the computer to determine a result of said attempt to authenticate said message, based at least partly on a response received to said request; and
computer readable program code for causing the computer to report that said message is considered authentic, or to report that said message is considered not authentic.
